(19) United States
(12) Patent Application Publication
(10) Pub. No.: US 2025/0018484 A1
(43) Pub. Date: Jan. 16, 2025

(54) Devices With Cutting Chains and Link Configurations

(71) Applicant: Chain Orthopedics, LLC, Bogota, NJ (US)

(72) Inventors: Charles LUDDY, Alexandria, VA (US); Paul VIOLA, Bogota, NJ (US); Timothy J. LANGLOSS, Berwyn, PA (US)

(73) Assignee: Chain Orthopedics, LLC, Bogota, NJ (US)

(21) Appl. No.: 18/761,735

(22) Filed: Jul. 2, 2024

Related U.S. Application Data
(60) Provisional application No. 63/575,027, filed on Apr. 5, 2024.
(60) Provisional application No. 63/512,962, filed on Jul. 11, 2023.

(51) Int. Cl. B23D 57/02; B27B 17/02; B27B 33/14

(52) U.S. Cl. CPC B23D 57/02; B27B 17/02; B27B 33/142; B27B 33/141

(57) ABSTRACT

Devices (e.g., chain saws, other tools, etc.) are disclosed with a plurality of links arranged in a chain. A first link comprises a hook that engages a recess of a second link, thereby coupling the links and allowing them to pivot with respect to each other. The links may comprise fins adapted to be positioned in corresponding pockets to inhibit lateral dislocation. A gate may be provided to enable the links to be coupled laterally. One or more closures such as deformable ribs may be provided for closing the gate, and/or a snap-fit such as with a retention ledge may be provided for retention of the fin in the pocket. The links may also have a protruding tab adapted to be positioned in an indented socket of an adjacent link. The links may be tapered. A chain may have one or more spacer links.

### CROSS-REFERENCE TO RELATED APPLICATIONS

This application claims priority to U.S. Provisional Patent Application No. 63/512,962, filed Jul. 11, 2023, entitled “Devices with Cutting Chains and Link Configurations,” and U.S. Provisional Patent Application No. 63/575,027, filed Apr. 5, 2024, entitled “Devices with Cutting Chains and Link Configurations.” The entire contents of these applications are incorporated herein by reference.

This application is related to U.S. Provisional Patent Application No. 63/058,216, filed Jul. 29, 2020, entitled “Thin Single Width Chain Saw,” U.S. Provisional Patent Application No. 63/085,290, filed Sep. 30, 2020, entitled “Thin Single Width Chain Saw,” U.S. Provisional Patent Application No. 63/147,033, filed Feb. 8, 2021, entitled “Chain Saws and Components for Chain Saws,” U.S. Provisional Patent Application No. 63/154,367, filed Feb. 26, 2021, entitled “Cutting Guide Systems,” U.S. Provisional Patent Application No. 63/154,379, filed Feb. 26, 2021, entitled “Systems and Methods for Manufacturing Saws and Saw Components,” U.S. Provisional Patent Application No. 63/195,994, filed Jun. 2, 2021, entitled “Cutting Guide Systems and Methods,” U.S. Provisional Patent Application No. 63/209,525, filed Jun. 11, 2021, entitled “Devices for Maintaining Tension in Chain Saws,” U.S. Provisional Patent Application No. 63/209,540, filed Jun. 11, 2021, entitled “Systems for Robotic Surgery,” U.S. Non-Provisional patent application Ser. No. 17/443,646, filed Jul. 27, 2021, entitled “Chain Saws, Components for Chain Saws, and Systems for Operating Saws,” International Application No. PCT/US2021/043433, filed Jul. 28, 2021, entitled “Chain Saws, Components for Chain Saws, and Systems for Operating Saws,” U.S. Provisional Patent Application No. 63/305,422, filed Feb. 1, 2022, entitled “Devices for Maintaining Tension in Chain Saws,” U.S. Provisional Patent Application No. 63/305,469, filed Feb. 1, 2022, entitled “Knives and Other Tools and Devices Incorporating Cutting Chains,” U.S. Non-Provisional patent application Ser. No. 17/590,192, filed Feb. 1, 2022, entitled “Cutting Guide Systems and Methods,” International Application No. PCT/US2022/014679, filed Feb. 1, 2022, entitled “Cutting Guide Systems and Methods,” U.S. Non-Provisional patent application Ser. No. 17/741,734, filed May 11, 2022, entitled “Devices for Maintaining Tension in Chain Saws,” International Application No. PCT/US2022/028792, filed May 11, 2022, entitled “Devices for Maintaining Tension in Chain Saws,” U.S. Provisional Patent Application No. 63/341,032, filed May 12, 2022, entitled “Safety Controls, Feedback, Cutting Variations, and Accessories for Chain Saws,” U.S. Provisional Patent Application No. 63/437,816, filed Jan. 9, 2023, entitled “Systems and Methods for Construction with Detection, Guidance, and/or Feedback,” U.S. Non-Provisional patent application Ser. No. 18/102,910, filed Jan. 30, 2023, entitled “Knives and Other Tools and Devices Incorporating Cutting Chains,” International Application No. PCT/US2023/011837, filed Jan. 30, 2023, entitled “Knives and Other Tools and Devices Incorporating Cutting Chains,” U.S. Non-Provisional patent application Ser. No. 18/315,003, filed May 10, 2023, entitled “Controls, Feedback, Cutting Variations, and Accessories for Chain Saws,” and International Application No. PCT/US2023/021684, filed May 10, 2023, entitled “Controls, Feedback, Cutting Variations, and Accessories for Chain Saws.” The entire contents of these applications are incorporated herein by reference.

### TECHNICAL FIELD

The present disclosure is directed to chain saws and other tools and devices incorporating cutting chains and to links for cutting chains.

### BACKGROUND

Various chain saws and other tools and devices incorporating cutting chains are known for performing tasks in various fields, such as surgery, construction, landscaping, and others.

U.S. Pat. No. 9,616,512 to Viola discloses a chain saw which may be used, for example, for cutting bone. The disclosure of U.S. Pat. No. 9,616,512 is hereby incorporated by reference herein in its entirety. U.S. Non-Provisional patent application Ser. No. 17/443,646, filed Jul. 27, 2021, entitled “Chain Saws, Components for Chain Saws, and Systems for Operating Saws,” and International Application No. PCT/US2021/043433, filed Jul. 28, 2021, entitled “Chain Saws, Components for Chain Saws, and Systems for Operating Saws,” the disclosures of which are incorporated by reference herein in their entirety, disclose chain saws, components for chain saws, methods of making chain saws and components, and methods of using chain saws and components.

U.S. Non-Provisional patent application Ser. No. 18/102,910, filed Jan. 30, 2023, entitled “Knives and Other Tools and Devices Incorporating Cutting Chains,” and International Application No. PCT/US2023/011837, filed Jan. 30, 2023, entitled “Knives and Other Tools and Devices Incorporating Cutting Chains,” the disclosures of which are incorporated by reference herein in their entirety, disclose knives and other tools and devices incorporating cutting chains.

A need exists for improvements to chain saws and other cutting devices (tools, etc.) incorporating cutting chains and to cutting links for cutting chains.

### SUMMARY

The present disclosure is directed improvements to chain saws and other cutting devices (tools, etc.) incorporating cutting chains and to links for cutting chains.

In some examples, a cutting device (e.g., a chain saw) comprises a bar and a plurality of links arranged in a chain along a chain path around the bar. A first link comprises a hook that engages a recess of a second link, thereby coupling the first link and the second link and allowing the first link and the second link to pivot with respect to each other as the chain is driven around the saw bar. In some examples, the plurality of links further comprises a fin located at one of a surface of the hook or a surface of the recess and a pocket located at the other of the surface of the hook and the surface of the recess, wherein the fin is adapted to be positioned in the pocket. The plurality of links may further comprise a gate adapted to permit the fin to pass through the gate in a lateral direction, thereby enabling the first link and the second link to be coupled and decoupled by lateral movement between the first link and the second link. The gate may be located on a side of the pocket. The gate may be located on only one side of the pocket.

In some examples, the plurality of links may further comprise one or more closures for closing the gate after the fin is passed through the gate in a lateral direction. The one or more closures may comprise one or more deformable ribs. In some examples, the plurality of links may further comprise a snap-fit for retention of the fin in the pocket after the fin is passed through the gate in a lateral direction. The snap-fit may comprise a retention ledge adjacent the gate opening.

In some examples, the plurality of links further comprises a fin located at one of an outer surface of the hook or an outer surface of the recess and a pocket located at the other of the outer surface of the hook and the outer surface of the recess, wherein the fin is adapted to be positioned in the pocket.

In some examples, the plurality of links further comprises a fin located at an inner surface of the hook of the first link and a pocket located at an outer surface of a rounded projection of the second link. The pocket may be defined by projections on each lateral side of the pocket. The projections may be partial disks. The projections may be wedges.

In some examples, the plurality of links further comprises a pocket located on an inner surface of the hook of the first link and a fin comprising one of a narrow rounded projection of the second link or a rounded projection of the second link with chamfered edges.

In some examples, a first link comprises one or more cutting teeth positioned along a first lateral side of the first link with no cutting teeth positioned along a second lateral side of the first link, and the second link comprises one or more cutting teeth positioned along a second lateral side of the second link with no cutting teeth positioned along a first lateral side of the second link.

In some examples, a first link comprises a protruding tab extending from a first adjacent link side of the first link, and the second link comprises an indented socket in a second adjacent link side of the second link. The protruding tab of the first link may be adapted to be positioned in the indented socket of the second link when the first link and the second link are longitudinally aligned. The protruding tab of the first link may be adapted to be positioned out of the indented socket of the second link when the first link and the second link are pivoted with respect to each other. The protruding tab may have an outer surface along a curved arc segment and the indented socket may have an outer surface along a corresponding curved arc segment. The protruding tab may comprise a body portion and a lip portion, and the indented socket may comprise a body recess and a lip recess.

In some examples, each link in the plurality of links comprises a hole or channel extending from a first adjacent link side to a second adjacent link side and adapted to receive a thread or wire.

In some examples, each of the first link and the second link is tapered along at least part of its height so that a bottom of the link is narrower than a top of the link. Each link may have a tapered body. Each link may have a tapered lower end. In some examples, each of the first link and the second link has at least one lateral side with one or more recesses that reduce(s) the contact surface of the lateral side.

In some examples, the chain comprises at least one spacer link with two hooks or two recesses. Each spacer link may or may not have one or more cutting teeth.

In some examples, a chain comprises a plurality of links, some of which are cutting links with cutting teeth and some of which are spacer links with or without cutting teeth. The cutting links in a single chain may take multiple forms, such as a first cutting link with one or more cutting teeth only on a first lateral side of the link and a second cutting link with one or more cutting teeth only on a second lateral side of the link. The cutting links and spacer links may be arranged in the chain in a pattern.

Further examples and features of embodiments of the invention will be evident from the drawings and detailed description.

### BRIEF DESCRIPTION OF THE DRAWINGS

The accompanying drawings illustrate examples disclosed herein and, together with the description, serve to explain the principles of the present disclosure.

FIG. 1A shows an example embodiment of a chain saw cartridge.

FIG. 1B shows a segment of a chain of cutting links.

FIG. 1C shows an enlarged view of a portion of the chain saw cartridge of FIG. 1A, with part of the chain removed.

FIG. 1D shows an enlarged perspective view of a portion of the chain saw cartridge of FIG. 1A, showing a cross-section through two links and the saw bar.

FIG. 1E shows a view of the cross-section of FIG. 1D.

FIG. 2A shows a side view of a first example cutting link.

FIG. 2B shows a perspective view of the cutting link of FIG. 2A.

FIG. 2C shows another perspective view of the cutting link of FIG. 2A.

FIG. 2D shows another perspective view of the cutting link of FIG. 2A.

FIG. 3A shows a side view of a second example cutting link.

FIG. 3B shows a perspective view of the cutting link of FIG. 3A.

FIG. 3C shows another perspective view of the cutting link of FIG. 3A.

FIG. 4A, like FIG. 1B, shows a segment of a chain of cutting links.

FIG. 4B shows the chain segment of FIG. 4A, with phantom lines to show internal/hidden features of the links.

FIG. 5A shows two coupled cutting links aligned longitudinally, with phantom lines to show internal/hidden features of the links.

FIG. 5B shows the coupled cutting links of FIG. 5A pivoted with respect to each other, with phantom lines to show internal/hidden features of the links.

FIG. 5C shows two coupled cutting links aligned longitudinally.

FIG. 5D shows the coupled cutting links of FIG. 5C pivoted with respect to each other.

FIG. 6A shows a perspective view of another example cutting link.

FIG. 6B shows a cross-sectional view of the cutting link of FIG. 6A.

FIG. 6C shows a side view of two coupled cutting links aligned longitudinally.

FIG. 6D shows a cross-sectional side view of the coupled cutting links of FIG. 6C pivoted with respect to each other.

FIG. 7A shows the coupled cutting links of FIG. 6C, with phantom lines to show internal/hidden features of the links.

FIG. 7B shows the coupled cutting links of FIG. 6C pivoted with respect to each other, with phantom lines to show internal/hidden features of the links.

FIG. 8A shows a perspective view of another example cutting link.

FIG. 8B shows another perspective view of the cutting link of FIG. 8A.

FIG. 8C shows another perspective view of the cutting link of FIG. 8A.

FIG. 8D shows a side view of two coupled cutting links pivoted with respect to each other.

FIG. 9A shows a perspective view of a chain of cutting links.

FIG. 9B shows a perspective view, generally from the top, of the chain of FIG. 9A.

FIG. 9C shows a side view of the chain of FIG. 9A under longitudinal compression.

FIG. 10A shows a perspective view of another example cutting link.

FIG. 10B shows another perspective view of the cutting link of FIG. 10A.

FIG. 10C shows a side view of two cutting links coupled together and aligned longitudinally.

FIG. 10D shows a side view of the cutting links of FIG. 10C with one cutting link pivoted with respect to the other cutting link.

FIG. 11A shows a side view of two coupled cutting links aligned longitudinally, with phantom lines to show internal/hidden features of the links.

FIG. 11B shows a side view of the cutting links of FIG. 11A pivoted with respect to each other, with phantom lines to show internal/hidden features of the links.

FIG. 12A shows a perspective view of another example cutting link.

FIG. 12B shows another perspective view of the cutting link of FIG. 12A.

FIG. 12C shows a side view of two coupled cutting links aligned longitudinally.

FIG. 12D shows a side view of the two cutting links of FIG. 12C pivoted with respect to each other.

FIG. 13A shows a side view of two coupled cutting links aligned longitudinally, with phantom lines to show internal/hidden features of the links.

FIG. 13B shows a side view of the cutting links of FIG. 13A pivoted with respect to each other, with phantom lines to show internal/hidden features of the links.

FIG. 14A shows a perspective view of another example cutting link.

FIG. 14B shows another perspective view of the cutting link of FIG. 14A.

FIG. 14C shows a side view of two coupled cutting links aligned longitudinally.

FIG. 14D shows a side view, in cross-section, of the coupled cutting links of FIG. 14C pivoted with respect to each other.

FIG. 15A shows a side view of two coupled cutting links aligned longitudinally, with phantom lines to show internal/hidden features of the links.

FIG. 15B shows a side view of the cutting links of FIG. 15A pivoted with respect to each other, with phantom lines to show internal/hidden features of the links.

FIG. 16A shows a perspective view of another example cutting link.

FIG. 16B shows another perspective view of the cutting link of FIG. 16A.

FIG. 16C shows two parts that can be assembled together to form the cutting link of FIG. 16A.

FIG. 17A shows a side view of three cutting links coupled together with the cutting links pivoted with respect to each other.

FIG. 17B shows a perspective view of the cutting links of FIG. 17A.

FIG. 17C shows a side view of the cutting links of FIG. 17A, with phantom lines to show internal/hidden features of the links.

FIG. 18A shows a perspective view of another example cutting link.

FIG. 18B shows another perspective view of the cutting link of FIG. 18A.

FIG. 18C shows a side view of three cutting links coupled together and pivoted with respect to each other.

FIG. 19A shows a perspective view of another example cutting link.

FIG. 19B shows another perspective view of the cutting link of FIG. 19A.

FIG. 19C shows a side view of two cutting links coupled together and aligned longitudinally.

FIG. 19D shows a side view of the two cutting links of FIG. 19C pivoted with respect to each other.

FIG. 20A shows a perspective view of another example cutting link.

FIG. 20B shows another perspective view of the cutting link of FIG. 20A.

FIG. 20C shows another view of the cutting link of FIG. 20A.

FIG. 21A shows another example cutting link.

FIG. 21B shows another view of the cutting link of FIG. 21A.

FIG. 21C shows another example cutting link.

FIG. 21D shows another view of the cutting link of FIG. 21C.

FIG. 22A shows a saw bar with a chain of links cutting through a material.

FIG. 22B shows another example cutting link.

FIG. 22C shows a side view of the cutting link of FIG. 22B.

FIG. 22D shows another example cutting link.

FIG. 22E shows a side view of the cutting link of FIG. 22D.

FIG. 23A shows another example cutting link.

FIG. 23B shows another example cutting link.

FIG. 23C shows a perspective view of the cutting link of FIG. 23B.

FIG. 23D shows another perspective view of the cutting link of FIG. 23B.

FIG. 24A shows a chain having spacer links.

FIG. 24B shows a perspective view of another example cutting link.

FIG. 24C shows another perspective view of the cutting link of FIG. 24B.

FIG. 25A shows another embodiment of two coupled cutting links aligned longitudinally.

FIG. 25B shows the coupled cutting links of FIG. 25A pivoted with respect to each other.

FIG. 25C shows an enlarged view of the gate area of the coupled cutting links of FIG. 25B.

FIG. 25D shows a cross-sectional view of the coupled cutting links of FIG. 25B.

FIG. 26A shows another embodiment of two coupled cutting links aligned longitudinally.

FIG. 26B shows the coupled cutting links of FIG. 26A pivoted with respect to each other.

FIG. 26C shows a cross-sectional view of the coupled cutting links of FIG. 26B.

FIG. 27A shows another embodiment of a chain of cutting links arranged around a saw bar.

FIG. 27B shows an enlarged view of a portion of the chain of cutting links of FIG. 27A.

The accompanying drawings may be better understood by reference to the following detailed description.

### DETAILED DESCRIPTION

For the purposes of promoting an understanding of the principles of the disclosure, reference will now be made to the examples illustrated in the drawings, and specific language will be used to describe those and other examples. It will nevertheless be understood that no limitation of the scope of the claims is intended by the examples shown in the drawings or described herein. Any alterations and further modifications to the illustrated or described systems, devices, components, or methods, and any further application of the principles of the present disclosure, are fully contemplated as would normally occur to one skilled in the art to which the disclosure relates. Features, components, and/or steps described with respect to one implementation of the disclosure may be combined with features, components, and/or steps described with respect to other implementations of the disclosure.

The designations “first” and “second” as used herein are not meant to indicate or imply a particular positioning or other characteristic. Rather, when the designations “first” and “second” are used herein, they are used only to distinguish one component or part from another. The terms “attached,” “connected,” “coupled,” and the like mean attachment, connection, coupling, etc., of one part to another either directly or indirectly through one or more other parts, unless direct or indirect attachment, connection, coupling, etc., is specified. The term “user” refers to one or more persons using the devices, systems, and/or methods described herein, such as one or more surgeons, physicians, operators, or other persons using the devices, systems, and/or methods.

Disclosed herein are various configurations of links and bars (e.g., saw bars) that may be used in a chain saw or other device (e.g., tool) incorporating a cutting chain. Aspects of the chain saw or other device (e.g., drive cog assembly, drive mechanism, etc.) used with components as disclosed herein may be similar to, but are not limited to, those disclosed in U.S. Pat. No. 9,616,512, U.S. Non-Provisional patent application Ser. No. 17/443,646, International Application No. PCT/US2021/043433, U.S. Non-Provisional patent application Ser. No. 18/102,910, and International Application No. PCT/US2023/011837.

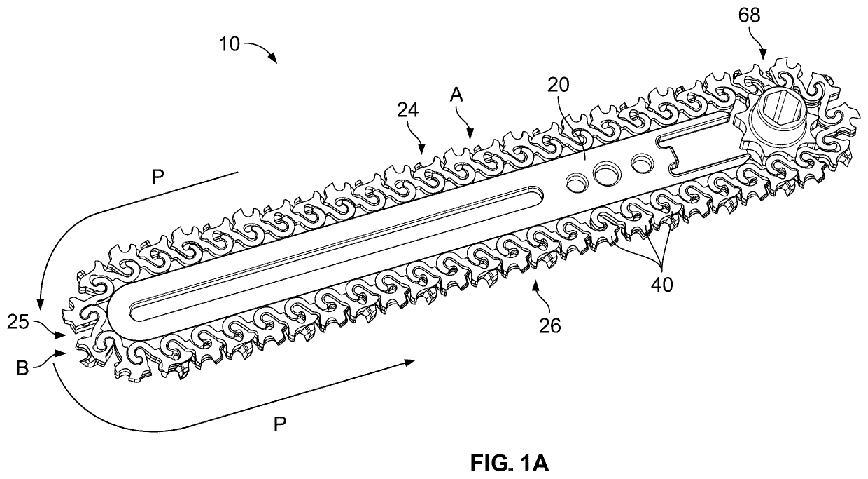

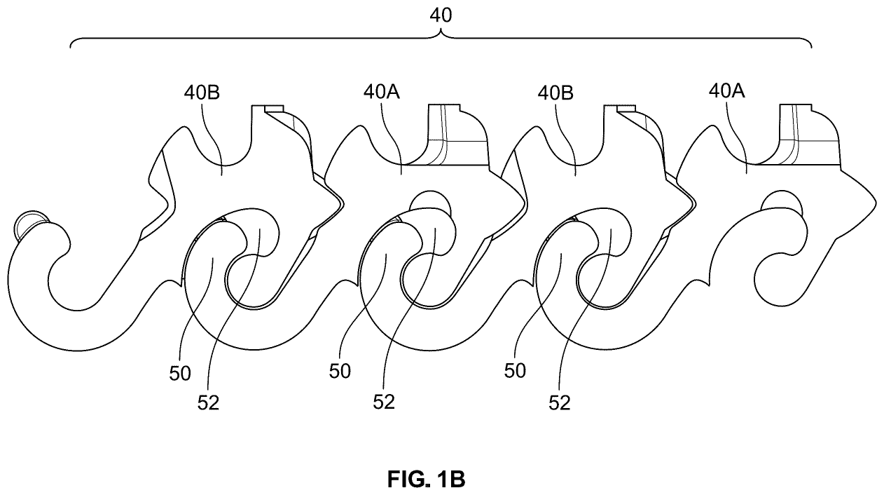

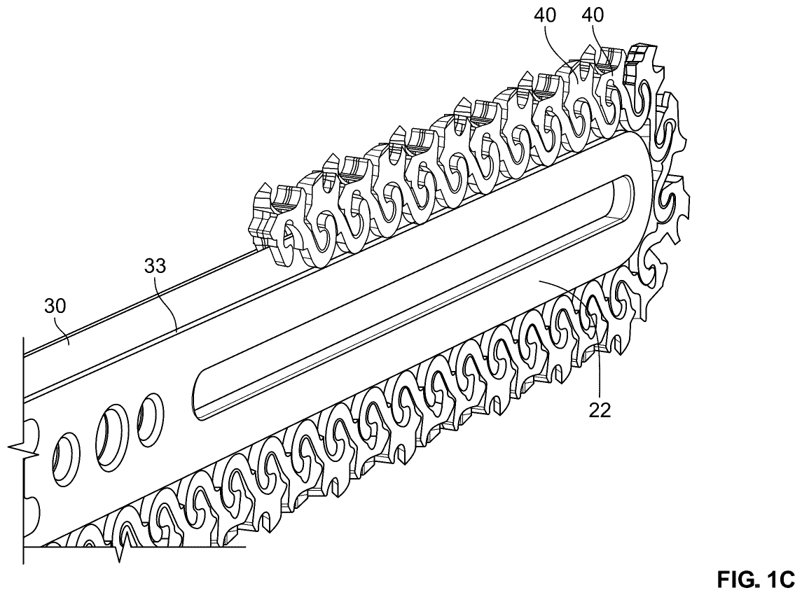

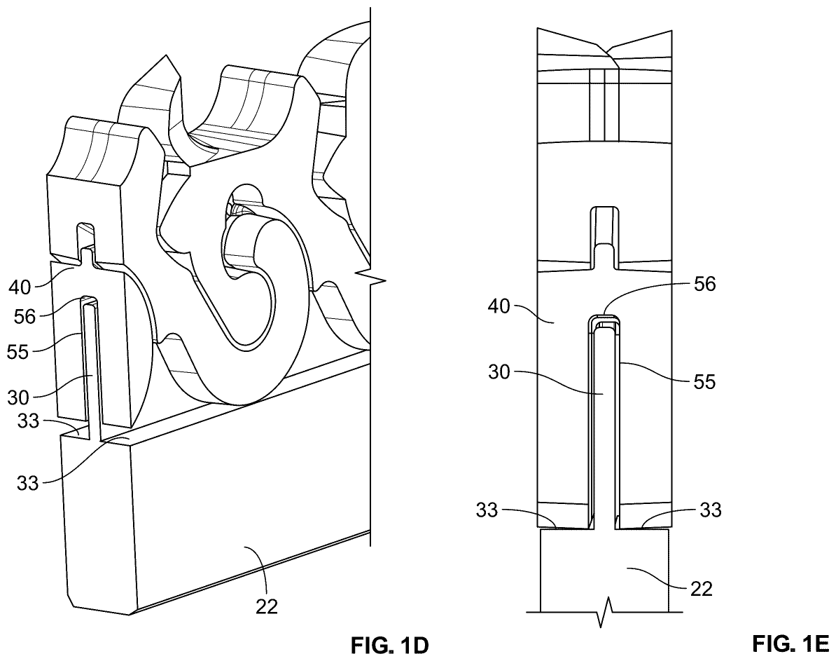

FIG. 1A shows an example embodiment of a chain saw cartridge 10. The chain saw cartridge 10 may be coupled to a housing with a suitable drive mechanism, together forming a chain saw. The chain saw may be used in various applications, such as surgery, construction, landscaping, etc. The chain saw may be used, for example, for cutting bone or other tissue in surgical procedures, such as knee surgery, vertebral surgery, and other potential bone or tissue cutting applications. The chain saw cartridge 10 in FIG. 1A comprises a saw bar 20, a plurality of cutting links 40A, 40B (cutting links 40A and 40B referred to herein collectively as cutting links 40) assembled together in a cutting chain around the bar 20, and a drive cog assembly 68.

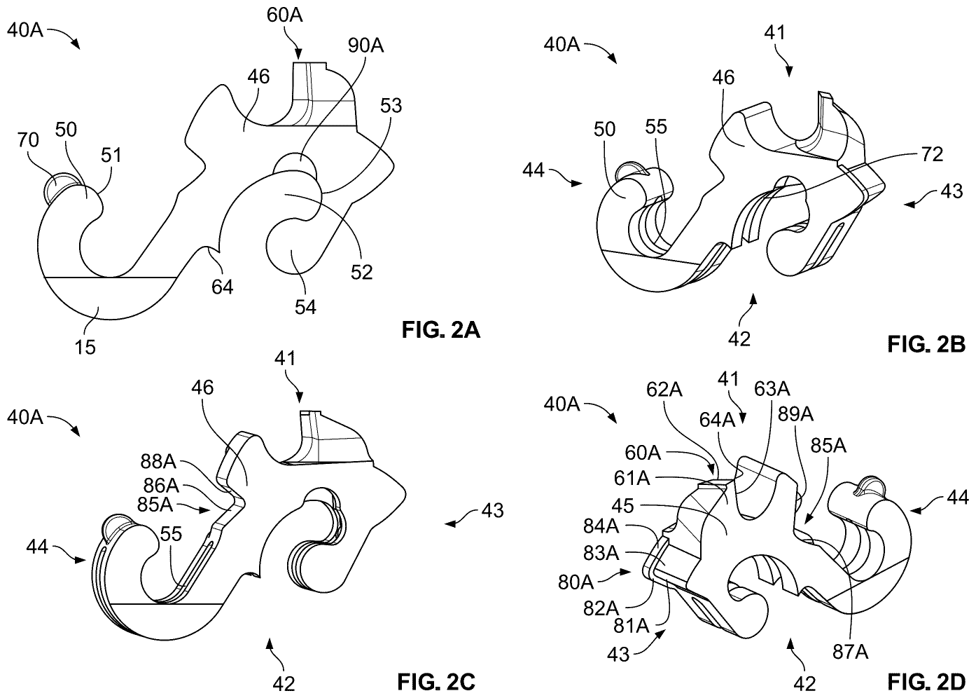

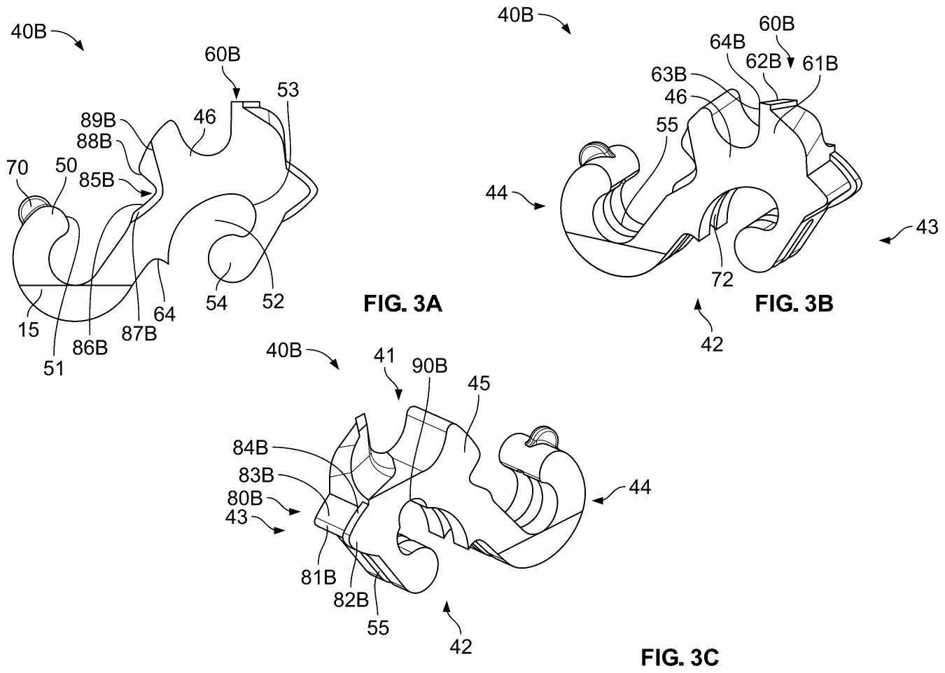

FIG. 1B shows a segment of a chain of cutting links 40A, 40B for a cutting chain of a chain saw such as the cutting chain of chain saw cartridge 10 in FIG. 1A. Each link 40A, 40B comprises a top or cutting side 41, a bottom or bar side 42, a first adjacent link side 43, a second adjacent link side 44, a first lateral side 45, and a second lateral side 46 (as labeled in FIGS. 2A-3C). In the chain segment of FIG. 1B, first cutting links 40A alternate with second cutting links 40B.

FIGS. 2A through 3C show further views of cutting links 40A, 40B. FIG. 2A shows a side view of a first cutting link 40A showing the second lateral side 46 of the link 40A. FIG. 2B shows a perspective view of the cutting link 40A showing the second lateral side 46 and the first adjacent link side 43. FIG. 2C shows another perspective view of the cutting link 40A showing the second lateral side 46 and the second adjacent link side 44. FIG. 2D shows another perspective view of the cutting link 40A showing the first lateral side 45 and the first adjacent link side 43.

FIG. 3A shows a side view of a second cutting link 40B showing the second lateral side 46 of the link 40B. FIG. 3B shows a perspective view of the cutting link 40B showing the second lateral side 46 and the first adjacent link side 43. FIG. 3C shows another perspective view of the cutting link 40B showing the first lateral side 45 and the first adjacent link side 43.

As can be seen in FIGS. 2A through 3C, each link 40A, 40B has a hook 50 and a recess 52. The link 40A, 40B has a rounded feature or projection 54 that defines one side of the recess 52. In this example embodiment, the hook 50 extends outward on the second adjacent link side 44 and upward from the bottom side 42, and the rounded projection 54 extends downward from the top side 41 and inward from the first adjacent link side 43. The recess 52 extends upward from the bottom side 42 and is shaped to receive a hook 50 of an adjacent link 40.

As shown in FIGS. 1A and 1B, a plurality of links 40A, 40B can be connected together in a chain to move along a predetermined path P around the bar 20. The recess 52 of one link receives the hook 50 of an adjacent link, whereby the hook 50 fits into the recess 52. The hook 50 of one link thereby interlocks with the rounded projection 54 of an adjacent link. When two adjacent links are in an aligned or non-articulated configuration with one another, such as along a straight part A of the bar 20, the distance between the tip 51 of the hook 50 and the end 53 of the recess 52 leaves a clearance, allowing for articulation. When two adjacent links are in an articulated configuration along a convex path with one another, such as along a convexly curved part B of the bar 20, the articulation causes the hook 50 to engage further into the recess 52, and distance between the tip 51 of the hook 50 and the end 53 of the recess 52 is smaller than along the straight part A. In some embodiments, at the full extent of articulation, i.e., the maximum degree of pivot between adjacent links during use, the tip 51 of the hook 50 is at its closest point to, and in some embodiments may touch, the end 53 of the recess 52.

The configuration of the links 40A, 40B with the hooks 50 and corresponding recesses 52 allows the links 40 to pivot with respect to each other and to remain connected to each other even as they pivot away from each other along a convexly curved path. Thus, the chain saw comprises saw bar and a plurality of links arranged in a chain around the saw bar, wherein a first link comprises a hook that engages a recess of a second link, thereby coupling the first link and the second link together and allowing the first and second link to articulate with respect to each other without decoupling as the chain is driven around the saw bar. The links 40A, 40B remain connected, avoiding longitudinal disarticulation, without the need for separate connecting elements such as rivets, pins, or other connectors. The width of the chain is as thin as the width of the cutting links 40, allowing a thin chain, for a thin kerf.

As shown in FIGS. 2A and 3A, the bottom side 42 of each link 40A, 40B has a drive cog engagement recess 64. The drive cog engagement recess 64 is for engagement by a drive cog of the drive cog assembly 68.

In the example chain segment in FIG. 1B, there are two versions of cutting links 40, namely first cutting links 40A and second cutting links 40B. When the links 40 are connected together in a chain as shown in FIG. 1B, the first cutting links 40A alternate with the second cutting links 40B. That is, a first cutting link 40A is coupled at its first adjacent link side 43 to a second cutting link 40B and at its second adjacent link side 44 to another second cutting link 40B. Similarly, a second cutting link 40B is coupled at its first adjacent link side 43 to a first cutting link 40A and at its second adjacent link side 44 to another first cutting link 40A.

At the top or cutting side 41, each cutting link 40A, 40B has one or more cutting elements or teeth 60A, 60B. In the illustrated embodiment, each first cutting link 40A has a cutting tooth 60A positioned on the first lateral side 45 of the cutting link 40A, while each second cutting link 40B has a cutting tooth 60B positioned on the second lateral side 46 of the cutting link 40B. The cutting elements or teeth may have any suitable shape and size. A single link or single chain may have any number of teeth and may have the same or a mix of different sizes, heights, and shapes of cutting teeth.

The cutting width of the links 40A, 40B (i.e., the width of the cut made by the chain) may be equal to or greater than the width of the saw bar so that the saw does not bind up. For a chain saw to pass through bone, for example, the width of the cut made by the chain typically should be equal to or greater than the width of the bar. If the saw bar is wider than the cut it will extend past the cut and could be bound by the bone (or other similarly hard material through which a cut is being made). In some embodiments, such as the example illustrated in FIGS. 1A-1B, the cutting elements 60A, 60B do not extend laterally beyond the planes of the lateral sides 45, 46 of the links 40A, 40B. In other examples, the cutting elements may extend beyond the lateral sides 45, 46 of the links 40A, 40B.

In the example illustrated in FIGS. 1B, 2A-2D, and 3A-3C, the cutting teeth 60A, 60A are configured as single-sided wedge tooth cutters. In the cutting links 40A, the cutting teeth 60A are configured with one side 61A coplanar with the first lateral side 45 of the cutting link 40A. The cutting tooth 60A has a top cutting edge 62A that angles downwardly (toward a bottom or bar side 42) and rearwardly (toward first adjacent link side 43) as it extends away from the first lateral side 45. The cutting tooth 60A also has a side cutting edge 63A coplanar with the first lateral side 45 of the cutting link 40A. The top cutting edge 62A and the side cutting edge 63A meet at a leading cutting point 64A. This configuration facilitates cutting material along the first lateral sides 45 of the chain of cutting links 40A, 40B. In the cutting links 40B, the cutting teeth 60B are configured with one side 61B coplanar with the second lateral side 46 of the cutting link 40B. The cutting tooth 60B has a top cutting edge 62B that angles downwardly (toward a bottom or bar side 42) and rearwardly (toward first adjacent link side 43) as it extends away from the second lateral side 46. The cutting tooth 60B also has a side cutting edge 63B coplanar with the second lateral side 46 of the cutting link 40B. The top cutting edge 62B and the side cutting edge 63B meet at a leading cutting point 64B. This configuration facilitates cutting material along the second lateral sides 46 of the chain of cutting links 40A, 40B. The arrangement of the cutting teeth 60A, 60B with surfaces substantially coplanar with the lateral sides 45, 46 of the links facilitates cuts that have relatively flat and relatively smooth sides. In addition, the configuration of cutting teeth helps prevent clogging, e.g., by fibrous tissue. Arranging cutting teeth along lateral sides of the links with an open area or valley in between gives room for removal of bone debris or other debris in the area or valley between the cutting teeth. Many other configurations of cutting teeth are possible. Cutting elements do not need to be on every link.

The saw bar 20 is generally planar, with a main body 22 that contributes the primary strength and stability of the bar and allows the links to transmit a normal load with respect to the downward pressure of cutting, i.e., a load that is directed normal to the chain path P and toward the saw bar 20. The bar has two sides 24, 26 in the longitudinal direction and a distal end 25 that in the embodiment of FIG. 1A is curved or semicircular. The bar has a recess at the proximal end, for accommodating a drive cog of the drive cog assembly 68. The sides 24, 26 may have extensions that facilitate transfer of the continuous link chain from the bar to the drive cog and from the drive cog to the bar. The first longitudinal side 24, the second longitudinal side 26, and the distal end 25 define at least part of a chain path P around the saw bar 20.

The saw bar 20 can have various other configurations. For example, the distal end 25 can be symmetrical and semicircular as shown in FIG. 1A, or it can have other shapes. In one alternative, the distal end can be asymmetrical, presenting a sloped face with rounded ends that projects more on one side of the saw than the other.

FIG. 1C shows an enlarged view of a portion of the saw bar 20, with part of a chain of links 40A, 40B assembled on the bar 20. FIG. 1D shows an enlarged perspective view of a portion of the chain saw cartridge of FIG. 1A, showing a cross-section through two links and the saw bar. FIG. 1E shows a view of the cross-section of FIG. 1D.

As shown in FIGS. 1C through 1E, the bar 20 has a rail 30 extending from the main body 22 of the bar 20. The rail 30 extends, in whole or in part, along the sides 24, 26 and the distal end 25 of the bar 20. In alternative embodiments, the rail 30 may extend only along part(s) of the chain path P around the saw bar 20. The rail 30 acts as a monorail along which the links 40A, 40B of the chain travel. The rail 30 generally extends in a direction away from the main body 22 of the bar 20. Although not included in the illustrated embodiment, the rail 30 in some embodiments may include a projection that extends laterally beyond one or both sides of the rail 30. The projection may act as a link lock or retention element that prevents the links 40A, 40B from coming off of the rail 30 in a direction away from the bar, i.e., in a direction away from the bar generally perpendicular to the direction of travel of the chain. In the example illustrated in FIGS. 1C through 1E, the rail 30 does not include such a projection.

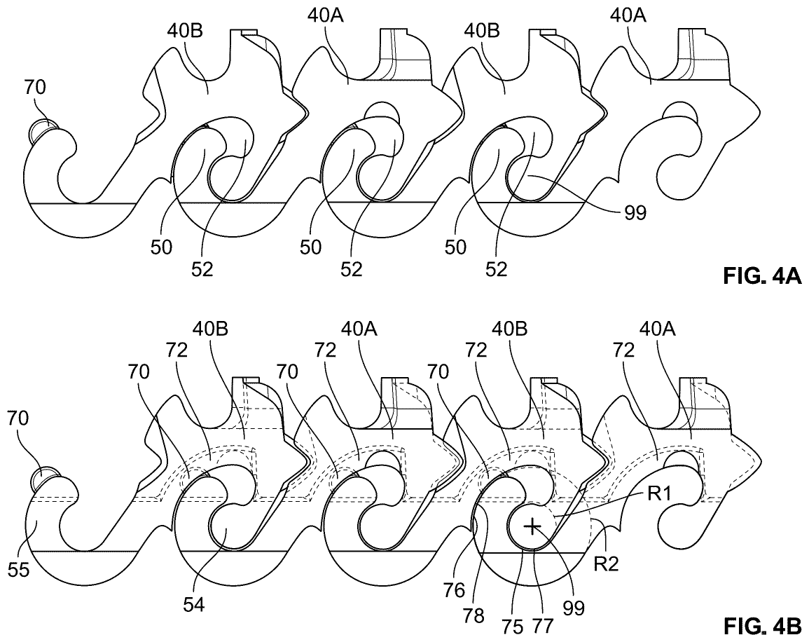

The links 40A, 40B have grooves 55 in them so that the links 40A, 40B fit over and straddle the monorail 30. As shown in FIGS. 1D and 1E and visible in dashed lines in FIG. 4B, each of the illustrated links 40A, 40B has a groove 55 that extends from the bottom side 42 of the link 40A, 40B upward part of the way to the top side 41 of the link 40A, 40B. The top end of the groove 55 is labeled as top end 56. The groove 55 runs parallel to and is located between the first lateral side 45 and the second lateral side 46 of each link 40A, 40B. The groove 55 extends the longitudinal length of each link 40A, 40B, from the first adjacent link side 43 through the rounded projection 54 through the link body and the second adjacent link side 44 and through the hook 50. In alternative embodiments (not shown), the groove 55 may include a notch that extends laterally beyond one or both sides of the groove 55, with the notch being shaped to accommodate a lateral projection of the rail 30 (in the event the rail 30 includes such a projection).

As shown in FIG. 1C, the grooves 55 of the links 40A, 40B accommodate the rail 30 of the saw bar 20, to allow the links 40A, 40B to travel around the saw bar 20, while keeping the links 40A, 40B aligned along the path P. In the illustrated example, when the links 40A, 40B are assembled on the rail 30, a clearance space is present between the top of the rail 30 and the top end 56 of the groove 55. Also, in this example, the width of the groove 55 is slightly wider than the width of the rail 30. This allows some small movement or play of the links 40A, 40B in a lateral direction with respect to the bar 20, while the rail 30 and grooves 55 inhibit excessive movement of the links 40 in a lateral direction with respect to the bar 20.

The configurations of the links 40A, 40B and the saw bar 20 result in the vertical load from the links 40A, 40B, i.e., the load in a direction normal to the chain path P directed into the saw bar, being taken up by the main body 22 of the saw bar 20 as opposed to the rail 30 itself. Vertical forces from the cutting elements of the links 40A, 40B are transmitted from the links 40A, 40B directly to the skids or ledges 33 of the saw bar 20 on either side of the rail 30. The rail 30 itself is not significantly loaded by these vertical forces. This arrangement tends to press the links 40A, 40B into place, while the rail 30 provides resistance to lateral movement or rocking motions of the links 40A, 40B.

In other words, the ledges 33 are where the normal downward load from the links 40A, 40B is primarily carried. The tangent sections at the bottom of the links 40A, 40B, i.e., the tangent sections at the bottom of the hook 50 and the projection 54, contact the ledges 33 on either side of the rail 30. Because of the groove 55, each link 40 straddles the rail 30, with one side of the link 40 contacting the ledge 33 on one side of the rail 30 and the other side of the link 40 contacting the ledge 33 on the other side of the rail 30. The separation of the right link side to ledge contact and left link side to ledge contact provides inherent stability and planar control of the link with respect to the bar. The ledges 33 bear the downward forces from the links 40A, 40B, resulting in stabilizing the links 40A, 40B and maintaining the links 40A, 40B in the same plane as the plane of the bar. This helps assure that the lateral sides of the links 40A, 40B remain substantially coplanar with the sides of the bar 20.

FIG. 4A, like FIG. 1B, shows a segment of a chain of first cutting links 40A alternating with second cutting links 40B for a cutting chain of a chain saw such as the cutting chain of chain saw cartridge 10 in FIG. 1A. FIG. 4B shows the chain segment of FIG. 4A with phantom lines to show internal/hidden features of the links.

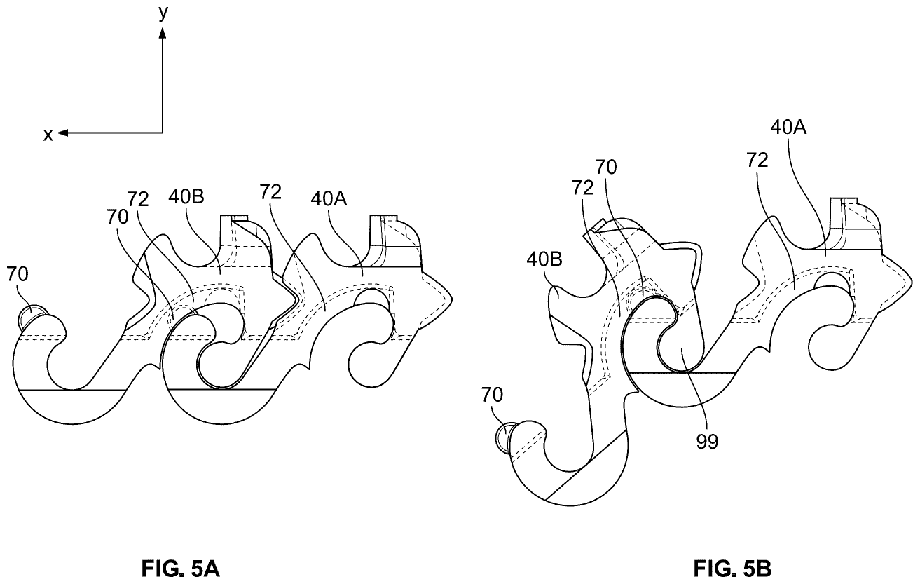

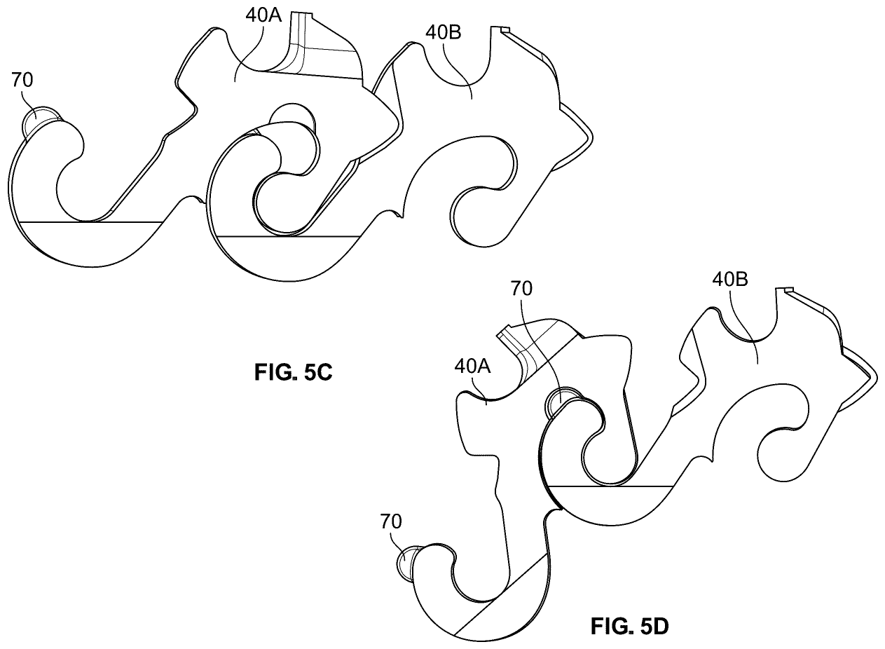

FIG. 5A shows a first cutting link 40A with a second cutting link 40B coupled to the second adjacent link side 44 of the first cutting link 40A, with the two cutting links aligned longitudinally with respect to each other, with phantom lines to show internal/hidden features of the links. FIG. 5B shows the coupled cutting links 40A, 40B of FIG. 5A, with the second cutting link 40B pivoted or articulated with respect to the first cutting link 40A, with phantom lines to show internal/hidden features of the links. FIG. 5C shows a first cutting link 40A with a second cutting link 40B coupled to the first adjacent link side 43 of the first cutting link 40A, with the two cutting links aligned longitudinally with respect to each other. FIG. 5D shows the coupled cutting links 40B, 40A of FIG. 5C, with the first cutting link 40A pivoted or articulated with respect to the second cutting link 40B.

As can be seen in FIGS. 2A through 5D, each of the cutting links 40A, 40B has a fin 70 in the form of an extension from the hook 50. As used herein, the terms “fin” and “pocket” are cooperating parts. The pocket is a groove or channel within which the fin can be positioned when two adjacent cutting links are coupled. The fin may be an extension, tab, ridge, narrowed structure, or other element capable of being positioned in the pocket. The pocket has a side wall on each side. When the fin is positioned in the pocket, the pocket allows movement of the fin within the pocket in the plane of the pocket (i.e., parallel to the x-y plane labeled in FIG. 5A), while side walls of the pocket inhibit movement of the fin in a lateral direction with respect to the pocket. Similarly, the fin allows movement of the adjacent link (i.e., the link having the pocket in which the fin is positioned) in the plane of the pocket, while the fin inhibits movement of the side walls of the pocket of the adjacent link in a lateral direction with respect to the fin. The permitted relative movement between the fin and pocket in the x-y plane allows the two adjacent cutting links to be pivoted with respect to each other while keeping the lateral sides of the cutting links coplanar and inhibiting the cutting links from decoupling.

In the embodiment of FIGS. 2A through 5D, the fin or hook extension 70 may be narrower than the hook 50. The illustrated hook extension 70 is shaped as a partial circular disk or crescent, but numerous other shapes are possible.

As can be seen in FIGS. 2A through 5D, each of the cutting links 40A, 40B has a pocket 72 in the form of a hook extension pocket in its interior. The pocket 72 serves as a groove or channel within which the hook extension 70 of an adjacent, coupled link may be retained during use of the chain of links 40.

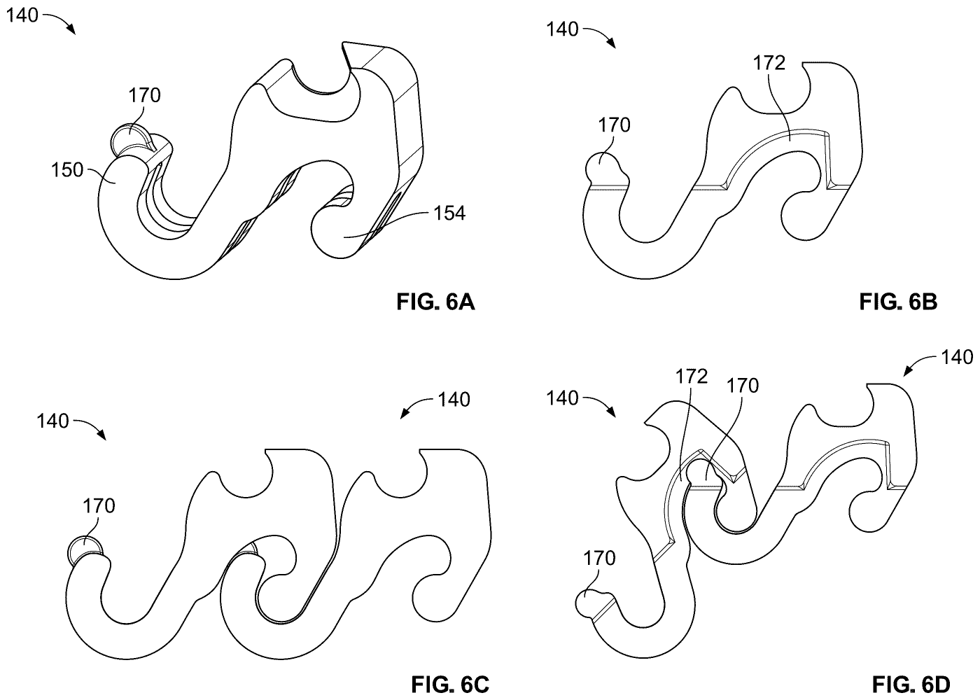

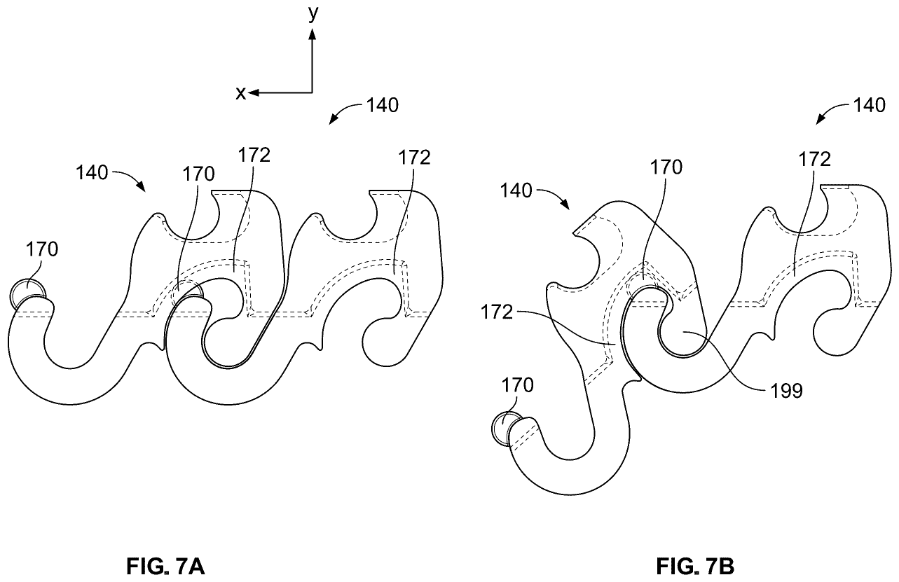

FIGS. 6A through 7B illustrate further examples of cutting links 140. Each of the cutting links 140 has a fin or hook extension 170 and pocket or hook extension pocket 172 similar to the fin or hook extension 70 and pocket or hook extension pocket 72 of the cutting links 40A, 40B.

FIG. 6A shows a perspective view of an example cutting link 140. FIG. 6B shows a cross-sectional view of the cutting link 140, bisecting the cutting link 140 in the longitudinal direction. FIG. 6C shows a side view of two cutting links 140 coupled together and aligned longitudinally with respect to each other. FIG. 6D shows a cross-sectional side view of two cutting links 140 coupled together with one cutting link 140 pivoted or articulated with respect to the other cutting link 140.

FIG. 7A shows a side view of two cutting links 140 coupled together and aligned longitudinally with respect to each other, with phantom lines to show internal/hidden features of the links. FIG. 7B shows a side view of two cutting links 140 coupled together with one cutting link 140 pivoted or articulated with respect to the other cutting link 140, with phantom lines to show internal/hidden features of the links.

As can be seen in FIGS. 6A through 7B, each of the cutting links 140 has a fin 170 in the form of a hook extension 170 extending from the hook 150. The hook extension 170 may be narrower than the hook 150. The illustrated hook extension 170 is shaped as a partial circular disk or crescent, but numerous other shapes are possible. Each of the cutting links 140 has a pocket 172 in the form of a hook extension pocket in its interior. The hook extension pocket 172 serves as a channel within which the hook extension 170 of an adjacent, coupled link may be retained during use of the chain of links 140.

For ease of reference in describing various functionality herein, FIGS. 5A and 7A include x-axis and y-axis labels, and the following positional references are used herein (although it will be understood that the positioning is relative and other nomenclature may be used). The saw bar, such as saw bar 20 in FIG. 1A, is considered to be in the x-y plane, with the sides 24, 26 aligned parallel with the x-axis (the x-axis and y-axis move with the saw bar as the saw bar is moved, such that saw bar remains in the x-y plane and the sides 24, 26 remain aligned parallel with the x-axis). The direction of travel of the cutting links 40, 140 around the saw bar 20 is generally in the x-y plane. Along the straight parts A of the saw bar 20, adjacent links 40, 140 are in an aligned or non-articulated configuration in a longitudinal direction, parallel to the x-axis. In the examples illustrated in FIGS. 5A, 5C, and 7A, the links are in an aligned or non-articulated configuration in a longitudinal direction, parallel to the x-axis. The coupled links are pivotable with respect to each other around a pivot axis extending in the lateral direction, parallel to the z-axis (perpendicular to the page in FIGS. 5A-D and 7A-B). The pivot axis is labeled as pivot axis 99 in FIG. 5B and pivot axis 199 in FIG. 7B. In the examples illustrated in FIGS. 5B, 5D, and 7B, one link has been pivoted with respect to the other around its pivot axis 99, 199.

When the cutting links 140 are assembled together as shown in FIGS. 6C-6D and 7A-7B, the fin or hook extension 170 within the corresponding hook extension pocket 172 helps resist lateral dislocation or separation of the links 140 from each other. In other words, movement of one link 140 relative to the adjacent coupled link 140 in the lateral direction is resisted. The resistance of such lateral dislocation is facilitated by the overlap of the two coupled links at the area of the fin or hook extension 170 when viewed laterally (i.e., from the side, as shown in FIGS. 7A-7B). As can be seen in FIG. 7A, when viewed laterally, a significant portion (or in some embodiments all) of the fin or hook extension 170 overlaps with the side walls on each side of the hook extension pocket 172 of the adjacent link 140. The side walls of the hook extension pocket 172 resist movement of the hook extension 170 in the lateral direction. Similarly, the hook extension 170 resists movement of the side walls of the hook extension pocket 172 in the lateral direction. Thus, the hook extension 170 together with the side walls of the hook extension pocket 172 resist movement of the coupled links 140 with respect to each other in the lateral direction.

Returning to the example of FIGS. 2A-5D, when the cutting links 40A, 40B are assembled together as shown in FIGS. 4A, 5A, and 5C, the fin or hook extension 70 within the corresponding hook extension pocket 72 helps resist lateral dislocation or separation of the links 40A, 40B from each other. In other words, movement of one link 40A relative to the adjacent coupled link 40B in the lateral direction is resisted. The resistance of such lateral dislocation is facilitated by the overlap of the two coupled links 40A, 40B at the area of the fin or hook extension 70 when viewed laterally (i.e., from the side, as shown in FIG. 5A). As can be seen in FIG. 5A, when viewed laterally, a significant portion (or in some embodiments all) of the hook extension 70 overlaps with the side walls on each side of the hook extension pocket 72 of the adjacent link. The side walls of the hook extension pocket 72 resist movement of the hook extension 70 in the lateral direction. Similarly, the hook extension 70 resists movement of the side walls of the hook extension pocket 72 in the lateral direction. Thus, the hook extension 70 together with the side walls of the hook extension pocket 72 resist movement of the coupled links 40A, 40B with respect to each other in the lateral direction.

As can be seen in FIGS. 4A and 4B, the rotation or pivoting of one link with respect to a coupled link occurs around the pivot axis 99. The engaged hook 50 and recess 52 pivot with respect to each other. The inner surface 75 of the hook 50 slides with respect to the outer surface 77 of the rounded feature or projection 54 generally along the circumference of the circle labeled R1 in FIG. 4B. (Along at least part of the outer surface 77 of the rounded feature or projection 54, the outer surface 77 of the rounded feature or projection 54 is the same as the inner surface of the recess 52.) The outer surface 76 of the hook 50 slides with respect to the outer surface 78 of the recess 52 generally along the circumference of the circle labeled R2 in FIG. 4B.

In the cutting links 40, the fins 70 are located at, or on, the outer surfaces 76 of the hooks 50, while the pockets 72 are located at, or in, the outer surfaces 78 of the recesses 52. The fins 170 and pockets 172 are similarly located. In a variation, the pockets 72 may be located at, or in, the outer surfaces 76 of the hooks 50, while the fins 70 may be located at, or on, the outer surfaces 78 of the recesses 52. A single chain may comprise different types of links, with fins and pockets in different locations. The location of the fins 70 and pockets 72 along the outer surfaces 76, 78 of the hooks 50 and recesses 52 (generally along the circumference of circle R2 in FIG. 4B) can provide advantages such as structural integrity, robustness, less susceptibility to failure, etc. The fins of the links engaging the pockets of the adjacent links keep the linkage together during assembly (e.g., assembly of the chain on the saw bar) and operation.

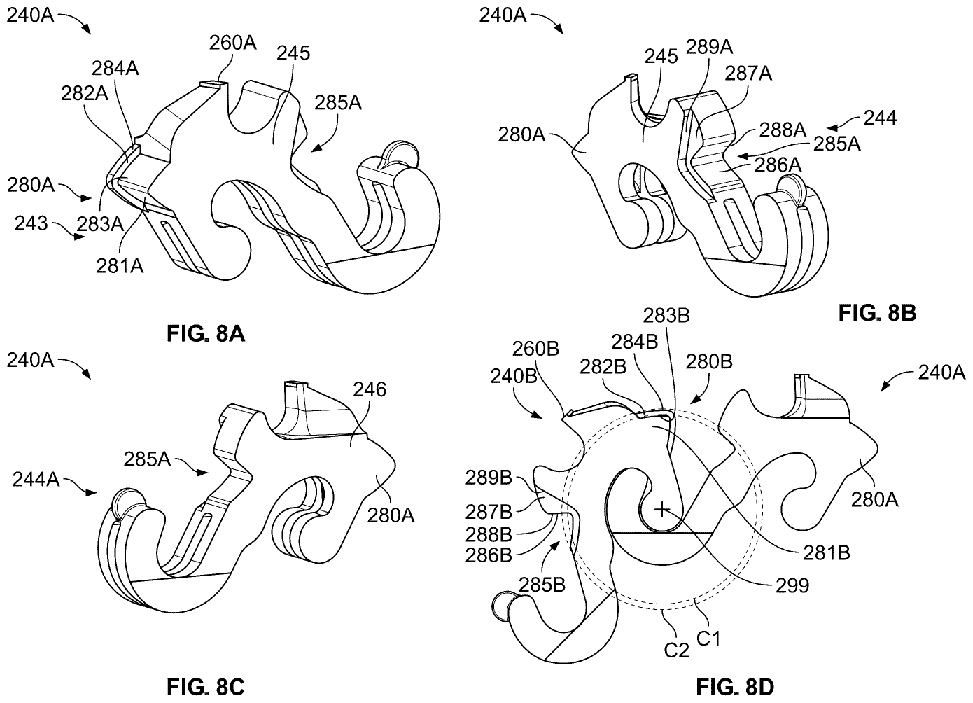

FIG. 8A shows a perspective view of a first cutting link 240A, similar to the cutting link 40A, showing the first lateral side 245 and the first adjacent link side 243. FIG. 8B shows another perspective view of the first cutting link 240A, showing the first lateral side 245 and the second adjacent link side 244. FIG. 8C shows another perspective view of the first cutting link 240A, showing the second lateral side 246 and the second adjacent link side 244. FIG. 8D shows the first cutting link 240A coupled to a second cutting link 240B, with the second cutting link 240B pivoted, around pivot axis 299, with respect to the first cutting link 240A.

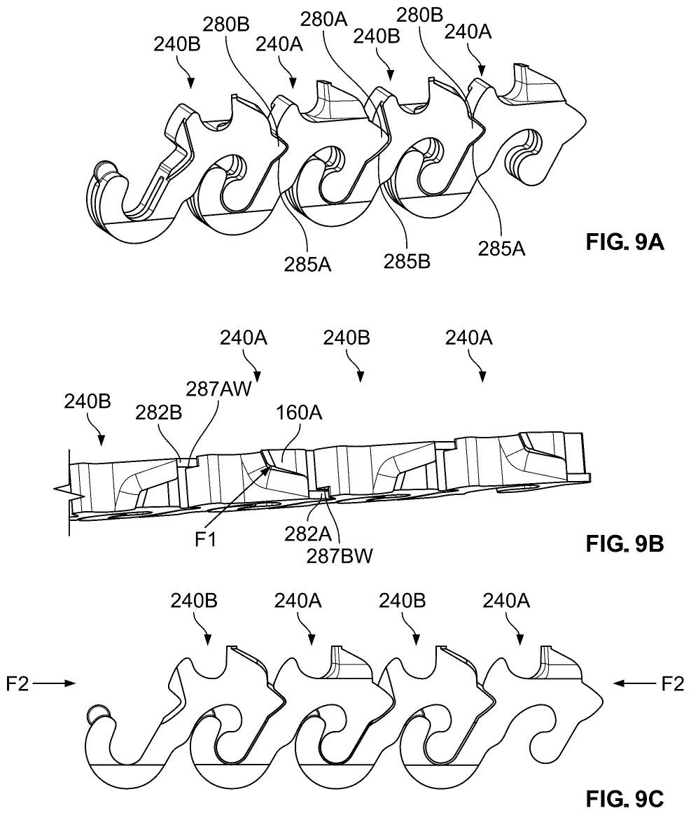

FIG. 9A shows a perspective view, generally from the side, of a chain of first cutting links 240A and second cutting links 240B (collectively, cutting links 240). FIG. 9B shows a perspective view, generally from the top, of the chain of FIG. 9A. FIG. 9C shows a side view of the chain of FIG. 9A under longitudinal compression.

Similar to the cutting links 40A and 40B, in the example embodiment in FIGS. 8A-9C, there are two versions of cutting links 240, namely first cutting links 240A and second cutting links 240B. When the links 240 are connected together in a chain as shown in FIGS. 9A-9C, the first cutting links 240A alternate in the chain with the second cutting links 240B.

In the illustrated example, each first cutting link 240A and second cutting link 240B has a protruding tab 280A, 280B extending from the first adjacent link side 243. The protruding tab 280A, 280B may have a body portion 281A, 281B and a lip portion 282A, 282B, wherein the lip portion 282A, 282B extends beyond the body portion 281A, 281B. In the illustrated example, the body portion 281A, 281B of the protruding tab 280A, 280B has an outer surface 283A, 283B that is in the shape of an arc segment, wherein the arc segment lies on a circle C1 that has its center at the pivot axis 299. Similarly, the lip portion 282A, 282B of the protruding tab 280A, 280B has an outer surface 284A, 284B that is in the shape of an arc segment, wherein the arc segment lies on a circle C2 that has its center at the pivot axis 299. As can be seen in FIG. 8D, the radius of the circle C2 is slightly larger than the radius of the circle C1.

In the illustrated example, each first cutting link 240A and second cutting link 240B has an indented socket 285A, 285B on the second adjacent link side 244. The indented socket 285A, 285B may have a body recess 286A, 286B and a lip recess 287A, 287B, wherein the lip recess 287A, 287B is further indented than the body recess 286A, 286B. In the illustrated example, the body recess 286A, 286B has an outer surface 288A, 288B positioned to allow the body portion 281B, 281A of an adjacent, coupled cutting link 240B, 240A to swing into and out of the body recess 286A, 286B as the coupled cutting link 240B, 240A is pivoted with respect to the cutting link 240A, 240B to which it is coupled. The outer surface 288A, 288B may be in the shape of an arc segment, wherein the arc segment lies on a circle (substantially equal to or slightly larger than circle C1) that has its center at the pivot axis 299. This allows the outer surface 283B, 283A of the body portion 281B, 281A of the adjacent, coupled link 240B, 240A to swing into and out of the body recess 286A, 286B without contact. The lip recess 287A, 287B has an outer surface 289A, 289B positioned to allow the lip portion 282B, 282A of an adjacent, coupled cutting link 240B, 240A to swing into and out of the lip recess 287A, 287B as the coupled cutting link 240B, 240A is pivoted with respect to the cutting link 240A, 240B to which it is coupled. Although not the case in the illustrated example, the outer surface 289A, 289B may be in the shape of an arc segment, wherein the arc segment lies on a circle (substantially equal to or slightly larger than circle C2) that has its center at the pivot axis 299. This allows the outer surface 284B, 284A of the lip portion 282B, 282A of the adjacent, coupled link 240B, 240A to swing into and out of the lip recess 287A, 287B without contact.

The first cutting links 240A and the second cutting links 240B differ from each other in the positioning of their cutting elements, protruding tabs, and indented sockets. In the illustrated embodiment, each first cutting link 240A has a cutting tooth 260A positioned on the first lateral side 245 of the cutting link 240A, while each second cutting link 240B has a cutting tooth 260B positioned on the second lateral side 246 of the cutting link 240B. In the example first cutting link 240A, the lip portion 282A is positioned on the second lateral side 246 of the first cutting link 240A, i.e., opposite the cutting tooth 260A which is positioned on the first lateral side 245 of the first cutting link 240A. Also, in the first cutting link 240A, the lip recess 287A is positioned on the first lateral side 245 of the first cutting link 240A, i.e., on the same side of the first cutting link 240A as the cutting tooth 260A. In the example second cutting link 240B, the lip portion 282B is positioned on the first lateral side 245 of the second cutting link 240B, i.e., opposite the cutting tooth 260B which is positioned on the second lateral side 246 of the second cutting link 240B. Also, in the second cutting link 240B, the lip recess 287B is positioned on the second lateral side 246 of the second cutting link 240B, i.e., on the same side of the second cutting link 240B as the cutting tooth 260B.

As shown in FIGS. 9A and 9C, when adjacent links 240 are longitudinally aligned with each other, the protruding tab 280A, 280B of one link 240 fits into the indented socket 285B, 285A of an adjacent link 240. The body portion 281A, 281B of one link 240 fits into the body recess 286B, 286A of the adjacent link 240, while the lip portion 282A, 282B of one link 240 fits into the lip recess 287B, 287A of the adjacent link 240.

The protruding tabs 280A, 280B, the body portions 281A, 281B, the lip portions 282A, 282B, and the corresponding indented sockets 285B, 285A, body recesses 286B, 286A, and lip recesses 287B, 287A help maintain alignment of the chain and/or help resist decoupling. For example, as illustrated in FIG. 9B, the cutting action of a cutting tooth 160A can generate a force against a first cutting link 140A generally in the direction of the arrow F1. This force F1 has components both in the longitudinal direction of the chain (along the x-axis) and in the lateral direction (along the z-axis). For a cutting link 140A, the lateral component of force F1 acts toward the first lateral side 245. The chain features resist this lateral force. For example, movement of the lip portion 282A in the lateral direction is resisted by the lateral wall 287BW of the lip recess 287B of an adjacent second link 240B. Similarly, movement of the lateral wall 287AW of the lip recess 287A is resisted by the lip portion 282B of an adjacent second link 240B.

Similarly, the cutting action of a cutting tooth 260B can generate a force against a second cutting link 240B with a lateral component toward the second lateral side 246. Movement of the lip portion 282B in the lateral direction is resisted by the lateral wall 287AW of the lip recess 287A of an adjacent first link 240A. Similarly, movement of the lateral wall 287BW of the lip recess 287B is resisted by the lip portion 282A of an adjacent first link 240A.

In certain situations, the chain can be subject to longitudinal compression, as indicated by the arrows F2 in FIG. 9C. For example, the cutting action can create a resistance to movement of the chain, resulting in tension along one longitudinal side 24, 26 of the saw bar and compression along the other longitudinal side 26, 24 of the saw bar. Under compressive forces, a chain ordinarily may have a tendency to buckle and/or dislocate. However, the protruding tabs 280A, 280B (e.g., the body portions 281A, 281B and the lip portions 282A, 282B), positioned in the corresponding indented sockets 285B, 285A (e.g., the body recesses 286B, 286A and the lip recesses 287B, 287A) create a mesh locking effect that resists buckling of the chain. Under compressive forces, the surface(s) of the protruding tabs 280A, 280B are pressed into the surface(s) of the corresponding indented sockets 285B, 285A. This mesh locking helps maintain alignment of the chain and helps resist decoupling.

Referring again to FIGS. 2A-5D, the cutting links 40A have protruding tabs 80A, body portions 81A (with outer surfaces 83A), lip portions 82A (with outer surfaces 84A), indented sockets 85A, body recesses 86A (with outer surfaces 88A), and lip recesses 87A (with outer surfaces 89A) that are similar in structure and function (as described above) to the protruding tabs 280A, body portions 281A (with outer surfaces 283A), lip portions 282A (with outer surfaces 284A), indented sockets 285A, body recesses 286A (with outer surfaces 288A), and lip recesses 287A (with outer surfaces 289A) of the cutting links 240A. Similarly, the cutting links 40B have protruding tabs 80B, body portions 81B (with outer surfaces 83B), lip portions 82B (with outer surfaces 84B), indented sockets 85B, body recesses 86B (with outer surfaces 88B), and lip recesses 87B (with outer surfaces 89B) that are similar in structure and function (as described above) to the protruding tabs 280B, body portions 281B (with outer surfaces 283B), lip portions 282B (with outer surfaces 284B), indented sockets 285B, body recesses 286B (with outer surfaces 288B), and lip recesses 287B (with outer surfaces 289B) of the cutting links 240B.

Returning to the embodiment illustrated in FIGS. 6A-7B, two cutting links 140 can be assembled together while both links 140 are in the same x-y plane. By maneuvering one link 140 with respect to the other link 140 within the same x-y plane, the hook extension 170 of one link can be assembled into the hook extension pocket 172 of the adjacent link, with the hook 150 in the corresponding recess 152, as shown in FIGS. 6C-6D and 7A-7B. Additionally, the two cutting links 140 can be assembled together in the same x-y plane either: (1) while they both are aligned longitudinally (as shown in FIGS. 6C and 7A) without pivoting of one link 140 with respect to the other link 140, or (2) with one link 140 pivoted at an angle with respect to the other link 140. While these features may assist in assembly of the chain, they may not be ideal in certain operating conditions, as it may result in easier decoupling of the links 140 from each other during operation of the chain saw.

In the embodiment illustrated in FIGS. 2A-5D, two cutting links 40A and 40B cannot be assembled together while both links are in the same x-y plane, due to the geometry of the links. For example, the hook 50 in the cutting links 40A, 40B extends further (curls around further) than the hook 150 in the cutting links 140A, 140B. Additionally, the rounded feature or projection 54 in the cutting links 40A, 40B extends further (curls around further) than the rounded feature or projection 154 in the cutting links 140A, 140B. In order to couple together the cutting links 40A, 40B, each cutting link 40A has a gate 90A located on its second lateral side 46, and each cutting link 40B has a gate 90B located on its first lateral side 45. The gate 90A, 90B is a space in one of the side walls of the hook extension pocket 72. The gate 90A, 90B is sized and shaped to allow the fin or hook extension 70 to be passed laterally through the gate 90A, 90B so that the fin or hook extension 70 can be positioned into, and removed from, the hook extension pocket 72. In order to assemble links 40A, 40B, the two links 40A, 40B are positioned in parallel planes, laterally displaced from one another, and angled (pivoted) with respect to each other so that the fin or hook extension 70 of one link is aligned with and next to the gate 90A or 90B of the other link (the relative angular positions as shown in FIGS. 5B and 5D). Then, for assembly, the links 40A, 40B are moved into lateral alignment to move the fin or hook extension 70 laterally through the gate 90A or 90B and into the hook extension pocket 72. The fin 70 passes through the gate 90A or 90B, with the links still in parallel planes, until the links are coplanar, with the fin 70 positioned in the pocket 72. When the relative angle (pivot angle) between the links is decreased, the fin 70 is captive by the pocket 72 of the adjacent link. In order to disassemble links 40A, 40B, two links are angled (pivoted) with respect to each other so that the fin or hook extension 70 is aligned with the gate 90A or 90B (the relative angular positions as shown in FIGS. 5B and 5D). Then, for disassembly, the links 40A, 40B are moved out of lateral alignment to move the hook extension 70 laterally through the gate 90A or 90B and out of the hook extension pocket 72.

The angle at which the links 40A, 40B must be positioned with respect to each other may be out of the range of angles that the links 40A, 40B pivot through during normal use of the chain saw. In one example embodiment, in order to position a fin or hook extension 70 into alignment with a gates 90A, 90B, the two adjacent cutting links 40A, 40B need to be pivoted to an angle of about 44 or 45 degrees with respect to each other, to the position shown in FIGS. 5B and 5D. In the same example, when positioned on the saw bar in the chain saw, the links 40A, 40B may need to pivot with respect to each other only to an angle of about 39 or 40 degrees as the chain moves around the curved distal end 25 of the saw bar or around the drive cog. At such an angle, the tip 51 of the hook 50 is at not as close to the end 53 of the recess 52 as the position shown in FIGS. 5B and 5D. Thus, during normal use of the chain saw, the cutting links 40A, 40B do not pivot enough to move the fins or hook extensions 70 into alignment with the gates 90A, 90B. Thus, the geometry helps avoid decoupling of the links 40 from each other during normal operation of the chain saw.

Additionally, while the gates may be on both sides of the cutting links (e.g., all the way through the cutting links), in the illustrated embodiment the gates are on only one side of the cutting links. Moreover, in the illustrated embodiment, the gates 90A in the cutting links 40A are on the second lateral side 46, while the gates 90B in the cutting links 40B are on the first lateral side 45, thereby alternating in the chain. In other embodiments, the gates 90A, 90B may be on the same sides of the cutting links 40A, 40B.

In an additional feature (not illustrated), the fins or hook extensions 70 on the cutting links 40A may have a shape and/or size that differs from the fins or hook extensions 70 on the cutting links 40B. The gates may be configured such that the fins or hook extensions 70 on the cutting links 40A only pass through the gates 90B of the cutting links 40B, while the fins or hook extensions 70 on the cutting links 40B only pass through the gates 90A of the cutting links 40A. This can help prevent the chain from being misassembled.

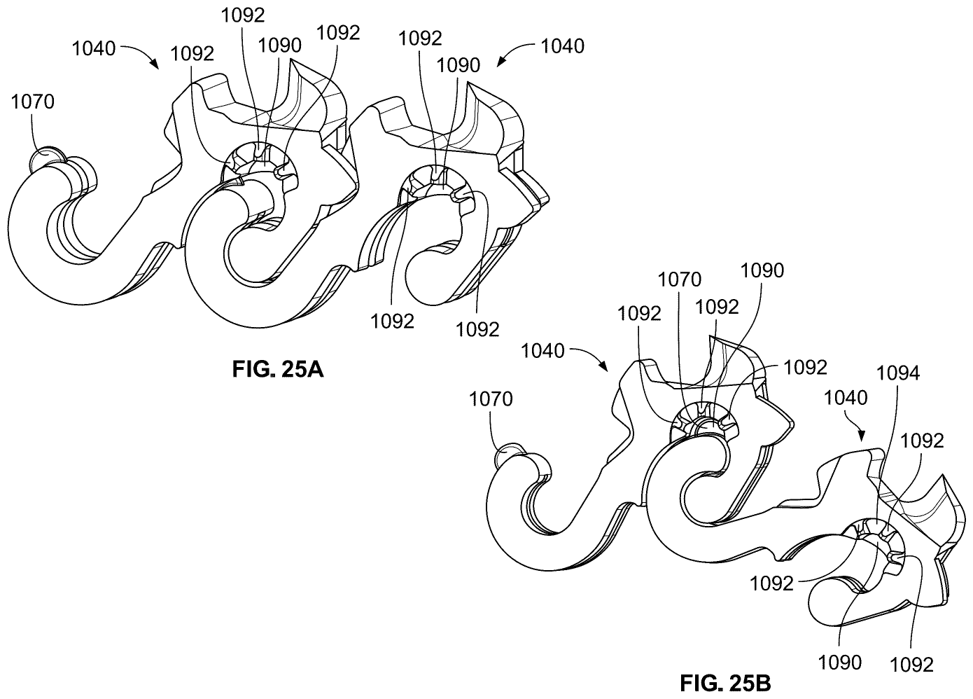

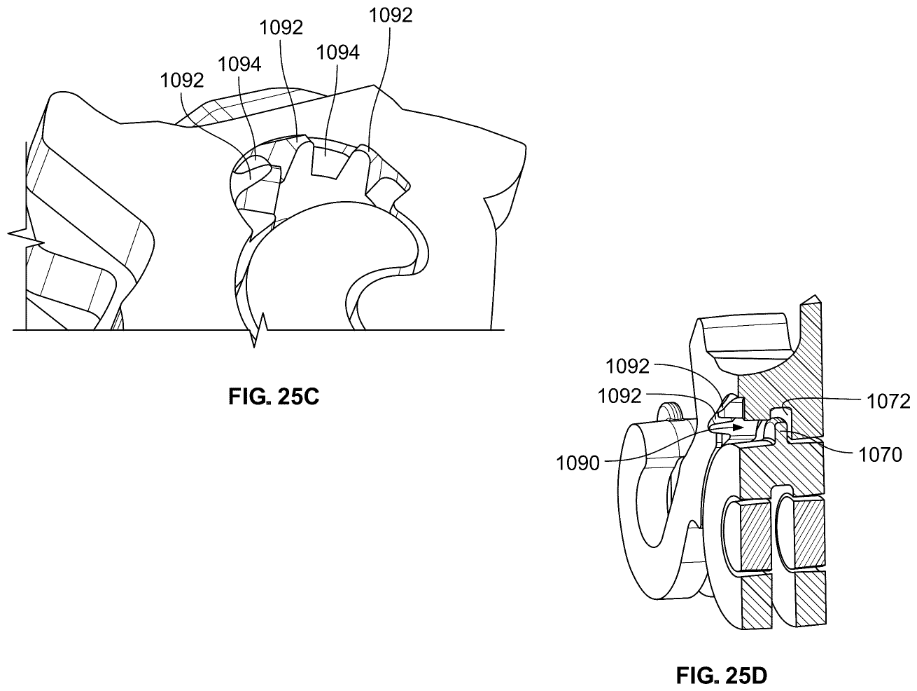

In some embodiments, a closure or flap may be provided to close the gates 90A, 90B after the cutting links are coupled, or to otherwise inhibit the fins from passing through the gates during use. This, too, can help prevent unintentional decoupling of the links. An example of the use of closures to close the gates after the cutting links are coupled is illustrated in FIGS. 25A-25D, described in more detail below.

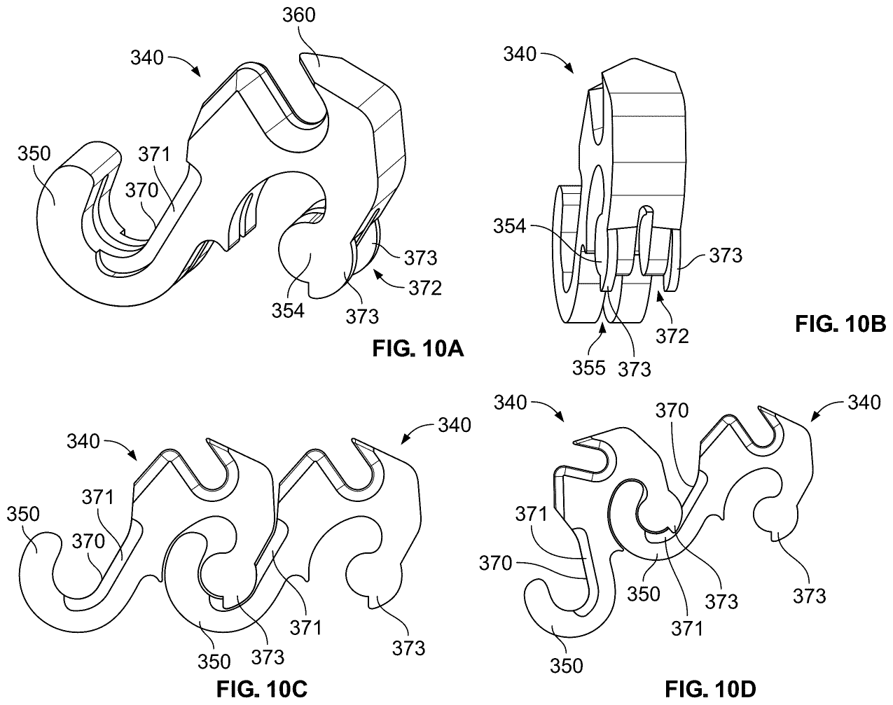

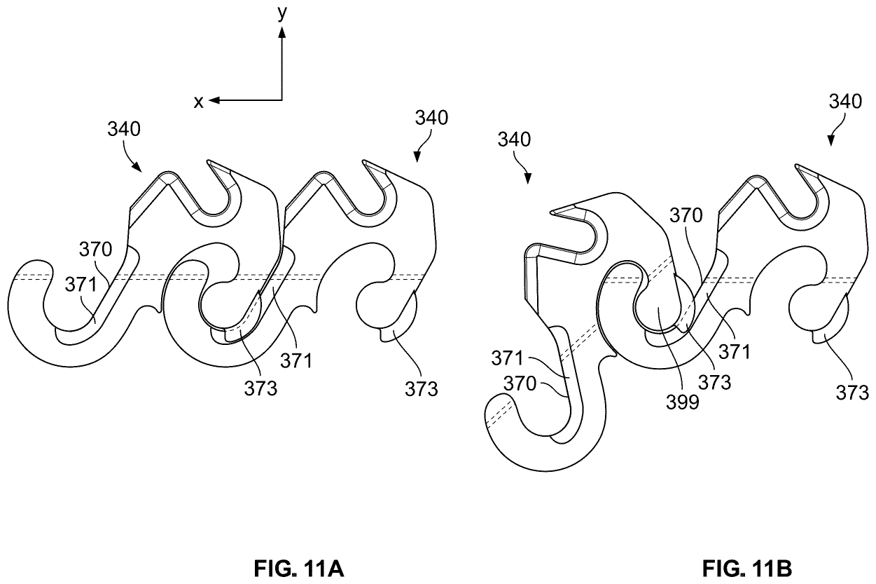

FIGS. 10A through 11B illustrate further examples of cutting links 340. FIG. 10A shows a perspective view of an example cutting link 340, generally toward the second lateral side. FIG. 10B shows another perspective view of a cutting link 340, generally toward the first adjacent link side. FIG. 10C shows a side view of two cutting links 340 coupled together and aligned longitudinally with respect to each other. FIG. 10D shows a side view of two cutting links 340 coupled together with one cutting link 340 pivoted or articulated with respect to the other cutting link 340.

FIG. 11A shows a side view of two cutting links 340 coupled together and aligned longitudinally with respect to each other, with phantom lines to show internal/hidden features of the links. FIG. 11B shows a side view of two cutting links 340 coupled together with one cutting link 340 pivoted or articulated with respect to the other cutting link 340, with phantom lines to show internal/hidden features of the links. When coupled, each link 340 is pivotable about a pivot axis 399.

As can be seen in FIGS. 10A through 11B, each of the cutting links 340 has a fin or hook ridge 370 and a pocket 372. The fin or ridge 370 is defined by grooves 371 on each lateral side of the hook 350, with the ridge 370 being between the grooves 371. The grooves 371 are located on the side of the hook 350 that faces the rounded feature or projection 354 of an adjacent link 340 when links 340 are coupled. The groove 355 in the link 340 for accommodating the rail of the saw bar may bisect the fin or ridge 370 and separate the fin or ridge 370 into two parts. The pocket 372 is formed by an extension or partial disk 373 extending from the rounded feature or projection 354 on each lateral side of the rounded feature or projection 354. The partial disks 373 are located on the side of the rounded feature or projection 354 that faces the hook 350 of an adjacent link 340 when links are coupled. The pocket 372 serves as a channel within which the fin or hook ridge 370 of an adjacent, coupled link may be retained during use of the chain of links 340. When links 340 are coupled as shown in FIGS. 10C-10D and 11A-11B, the disks 373 of one link 340 are positioned in the grooves 371 on either side of the ridge 370 of an adjacent link 340. In the cutting links 340, the fins 370 are located at, or on, the inner surfaces of the hooks 350, while the pockets 372 are located at, or in, the outer surfaces of the rounded features or projections 354.

When the cutting links 340 are assembled together as shown in FIGS. 10C-10D and 11A-11B, the fin or ridge 370 within the corresponding pocket 372 helps resist lateral dislocation or separation of the links 340 from each other. In other words, movement of one link 340 relative to the adjacent coupled link 340 in the lateral direction is resisted. The resistance of such lateral dislocation is facilitated by the overlap of the two coupled links at the area of the fin or ridge 370 when viewed laterally (i.e., from the side, as shown in FIGS. 11A-11B). As can be seen in FIG. 11A, when viewed laterally, a significant portion (or in some embodiments all) of the fin or ridge 370 overlaps with the side walls on each side of the pocket 372 (i.e., the sides of disks 373) of the adjacent link 340. The side walls of the hook extension pocket 372 (i.e., the sides of disks 373) resist movement of the fin or ridge 370 in the lateral direction. Similarly, the fin or ridge 370 resists movement of the side walls of the hook extension pocket 372 (i.e., the sides of disks 373) in the lateral direction. Thus, the fin or ridge 370 together with the side walls of the pocket 372 resist movement of the coupled links 340 with respect to each other in the lateral direction.

In the example shown in FIGS. 10A through 11B, each cutting tooth 360 is in the form of a single pyramid chip tooth cutter. The teeth may be along one side of the chain or may alternate or may be in any other suitable arrangement.

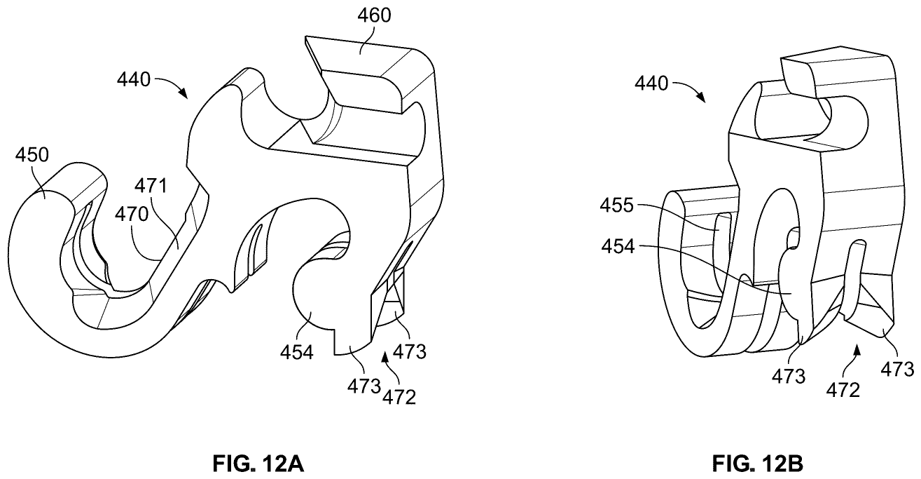

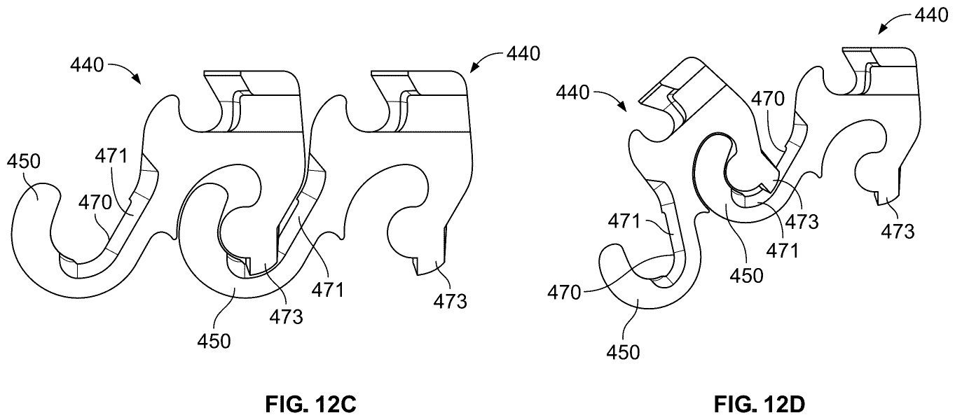

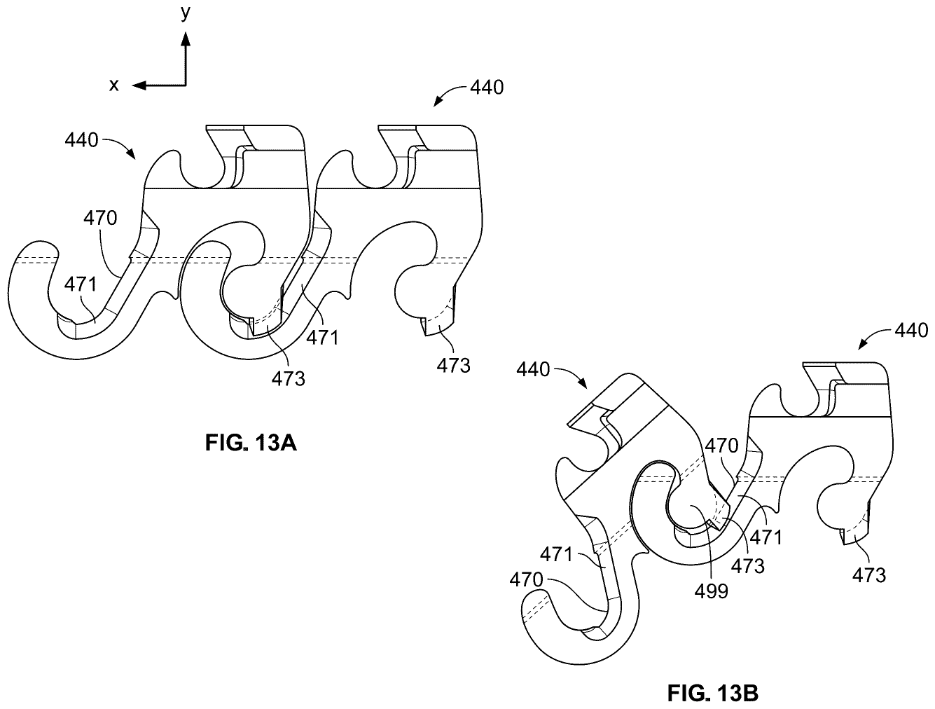

FIGS. 12A through 13B illustrate further examples of cutting links 440. FIG. 12A shows a perspective view of an example cutting link 440, generally toward the second lateral side. FIG. 12B shows another perspective view of a cutting link 440, showing the first adjacent link side and the second lateral side. FIG. 12C shows a side view of two cutting links 440 coupled together and aligned longitudinally with respect to each other. FIG. 12D shows a side view of two cutting links 440 coupled together with one cutting link 440 pivoted or articulated with respect to the other cutting link 440.

FIG. 13A shows a side view of two cutting links 440 coupled together and aligned longitudinally with respect to each other, with phantom lines to show internal/hidden features of the links. FIG. 13B shows a side view of two cutting links 440 coupled together with one cutting link 440 pivoted or articulated with respect to the other cutting link 440, with phantom lines to show internal/hidden features of the links. When coupled, each link 440 is pivotable about a pivot axis 499.

As can be seen in FIGS. 12A through 13B, each of the cutting links 440 has a fin or hook ridge 470 and a pocket 472. The fin or ridge 470 is defined by grooves or wedge rests 471 on each lateral side of the hook 450, with the ridge 470 being between the wedge rests 471. The wedge rests 471 are located on the side of the hook 450 that faces the rounded feature or projection 454 of an adjacent link 440 when links 440 are coupled. The groove 455 in the link 440 for accommodating the rail of the saw bar may bisect the fin or ridge 470 and separate the fin or ridge 470 into two parts. The pocket 472 is formed by an extension or curved wedge 473 extending from the rounded feature or projection 454 on each lateral side of the rounded feature or projection 454. The wedges 473 are located on the side of the rounded feature or projection 454 that faces the hook 450 of an adjacent link 440 when links are coupled. The pocket 472 serves as a channel within which the fin or hook ridge 470 of an adjacent, coupled link may be retained during use of the chain of links 440. When links 440 are coupled as shown in FIGS. 12C-12D and 13A-13B, the wedges 473 of one link 440 are positioned on the wedge rests 471 on either side of the ridge 470 of an adjacent link 440. In the cutting links 440, the fins 470 are located at, or on, the inner surfaces of the hooks 450, while the pockets 472 are located at, or in, the outer surfaces of the rounded features or projections 454.

When the cutting links 440 are assembled together as shown in FIGS. 12C-12D and 13A-13B, the fin or ridge 470 within the corresponding pocket 472 helps resist lateral dislocation or separation of the links 440 from each other. In other words, movement of one link 440 relative to the adjacent coupled link 440 in the lateral direction is resisted. The resistance of such lateral dislocation is facilitated by the overlap of the two coupled links at the area of the fin or ridge 470 when viewed laterally (i.e., from the side, as shown in FIGS. 13A-13B). As can be seen in FIG. 13A, when viewed laterally, a significant portion (or in some embodiments all) of the fin or ridge 470 overlaps with the side walls on each side of the pocket 472 (i.e., the sides of wedges 473) of the adjacent link 440. The side walls of the hook extension pocket 472 (i.e., the sides of wedges 473) resist movement of the fin or ridge 470 in the lateral direction. Similarly, the fin or ridge 470 resists movement of the side walls of the hook extension pocket 472 (i.e., the sides of wedges 473) in the lateral direction. Thus, the fin or ridge 470 together with the side walls of the pocket 472 resist movement of the coupled links 440 with respect to each other in the lateral direction.

In the example shown in FIGS. 12A through 13B, each cutting tooth 460 is in the form of a single-sided chisel tooth cutter. The teeth may be along one side of the chain or may alternate or may be in any other suitable arrangement.

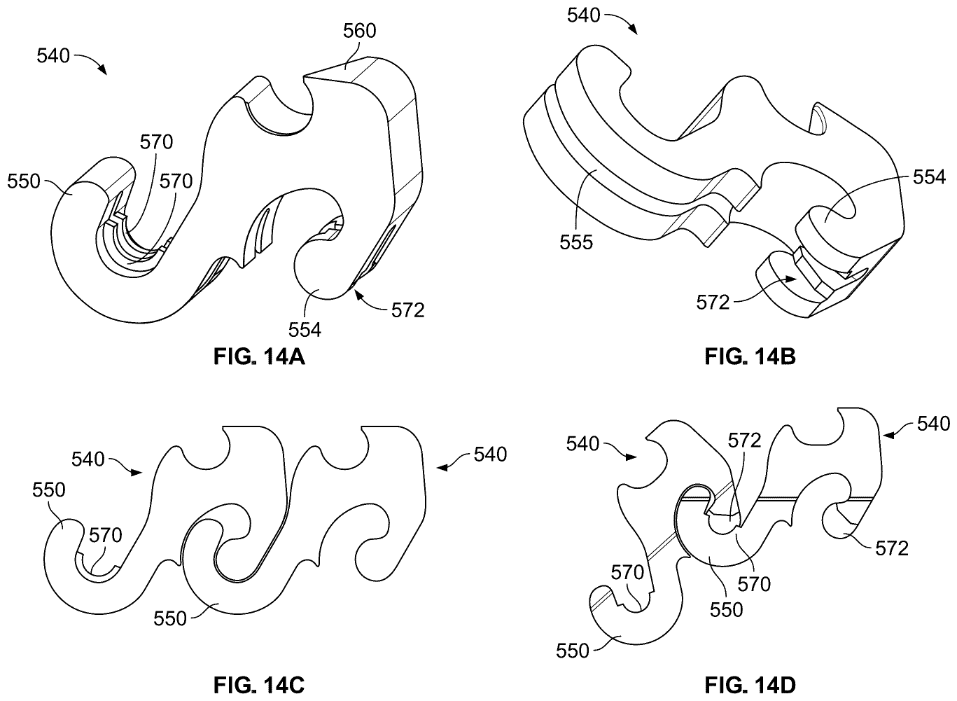

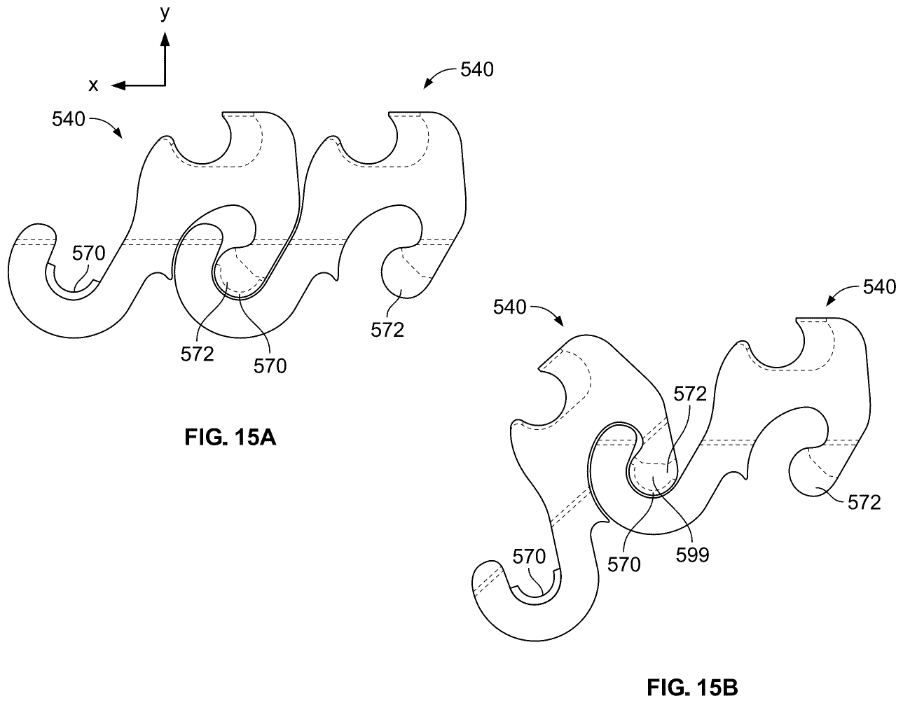

FIGS. 14A through 15B illustrate further examples of cutting links 540. FIG. 14A shows a perspective view of an example cutting link 540, generally toward the second lateral side. FIG. 14B shows another perspective view of a cutting link 540, generally toward the bottom side. FIG. 14C shows a side view of two cutting links 540 coupled together and aligned longitudinally with respect to each other. FIG. 14D shows a side view, in cross-section, of two cutting links 540 coupled together with one cutting link 540 pivoted or articulated with respect to the other cutting link 540.

FIG. 15A shows a side view of two cutting links 540 coupled together and aligned longitudinally with respect to each other, with phantom lines to show internal/hidden features of the links. FIG. 15B shows a side view of two cutting links 540 coupled together with one cutting link 540 pivoted or articulated with respect to the other cutting link 540, with phantom lines to show internal/hidden features of the links. When coupled, each link 540 is pivotable about a pivot axis 599.

As can be seen in FIGS. 14A through 15B, each of the cutting links 540 has a fin or ridge 570 and a pocket 572. The fin or ridge 570 is formed as an extension from the hook 550. The fin or ridge 570 is located on the side of the hook 550 that faces the rounded feature or projection 554 of an adjacent link 540 when links 540 are coupled. The groove 555 in the link 540 for accommodating the rail of the saw bar may bisect the fin or ridge 570 and separate the fin or ridge 570 into two parts. The fin or ridge 570 (or each part of the bifurcated fin or ridge 570) is generally U-shaped or horseshoe-shaped. The pocket 572 is in the form of a groove or channel in the rounded feature or projection 554. The pocket 572 is located on the side of the rounded feature or projection 554 that faces the hook 550 of an adjacent link 540 when links are coupled. The pocket 572 serves as a channel within which the fin or ridge 570 of an adjacent, coupled link may be retained during use of the chain of links 540. When links 540 are coupled as shown in FIGS. 14C-14D and 15A-15B, the fin or ridge 570 of one link 540 is positioned in the pocket 572 of an adjacent link 540. In the cutting links 540, the fins 570 are located at, or on, the inner surfaces of the hooks 550, while the pockets 572 are located at, or in, the outer surfaces of the rounded features or projections 554.

When the cutting links 540 are assembled together as shown in FIGS. 14C-14D and 15A-15B, the fin or ridge 570 within the corresponding pocket 572 helps resist lateral dislocation or separation of the links 540 from each other. In other words, movement of one link 540 relative to the adjacent coupled link 540 in the lateral direction is resisted. The resistance of such lateral dislocation is facilitated by the overlap of the two coupled links at the area of the fin or ridge 570 when viewed laterally (i.e., from the side, as shown in FIGS. 15A-15B). As can be seen in FIG. 15A, when viewed laterally, a significant portion (or in some embodiments all) of the fin or ridge 570 overlaps with the side walls on each side of the pocket 572 of the adjacent link 540. The side walls of the pocket 572 resist movement of the fin or ridge 570 in the lateral direction. Similarly, the fin or ridge 570 resists movement of the side walls of the 572 in the lateral direction. Thus, the fin or ridge 570 together with the side walls of the pocket 572 resist movement of the coupled links 540 with respect to each other in the lateral direction.

In the example shown in FIGS. 14A through 15B, each cutting tooth 560 is in the form of a single-sided wedge tooth cutter. The teeth may be along one side of the chain or may alternate or may be in any other suitable arrangement.

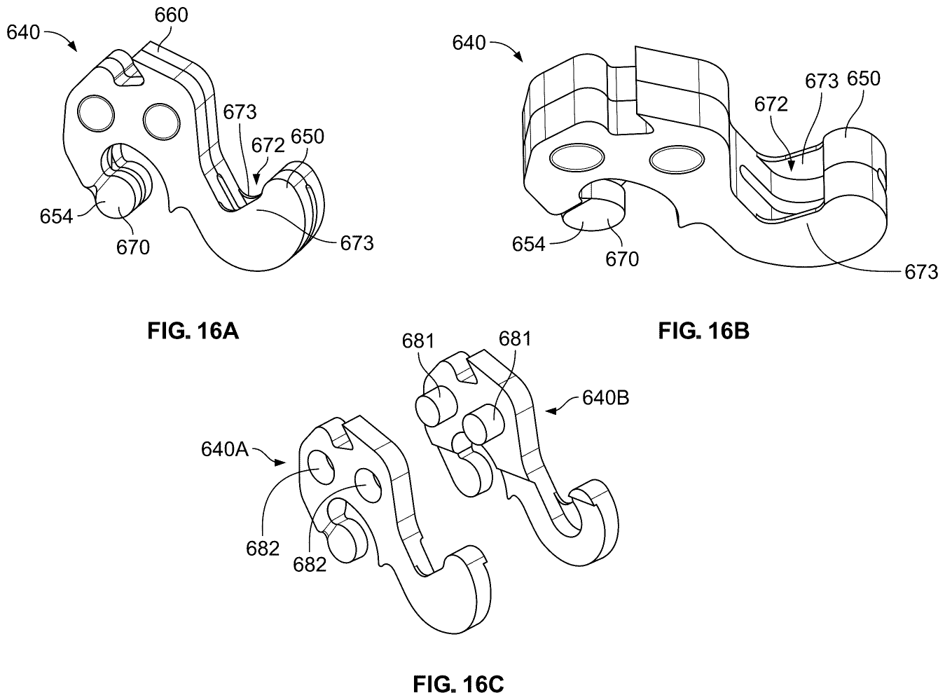

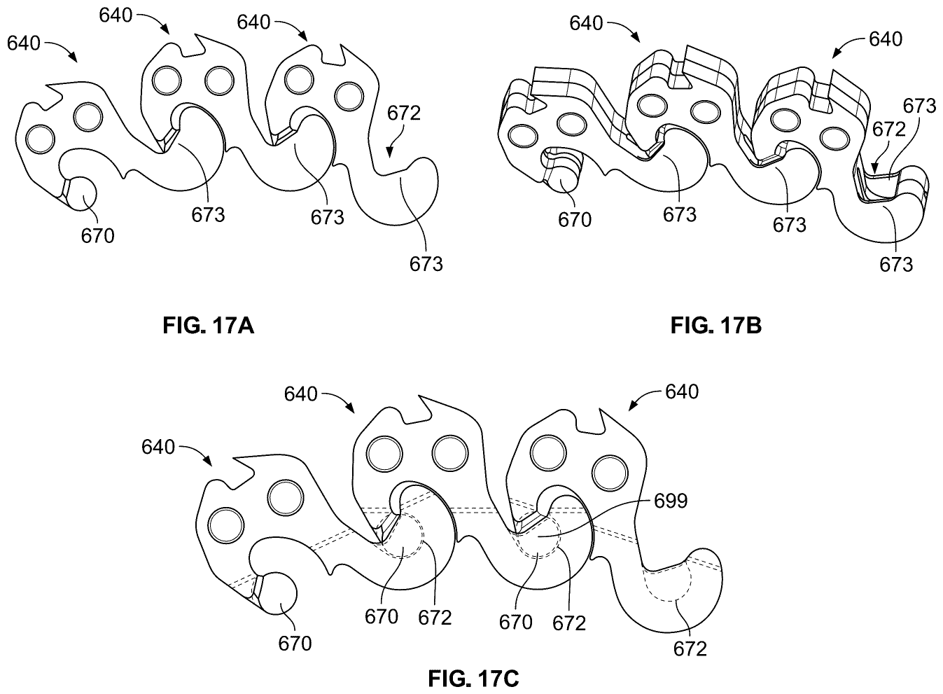

FIGS. 16A through 17C illustrate further examples of cutting links 640. FIG. 16A shows a perspective view of an example cutting link 640, generally toward the first lateral side. FIG. 16B shows another perspective view of a cutting link 640, generally toward the top side. FIG. 16C shows two parts 640A and 640B that can be assembled together to form a cutting link 640. Any suitable embodiment may be made in multiple parts and joined together, such as by gluing, welding, and/or fasteners. In this example, connectors 681 and holes 682 are shown for fastening the parts 640A and 640B together.

FIG. 17A shows a side view of three cutting links 640 coupled together with the cutting links 640 pivoted or articulated with respect to each other. FIG. 17B shows a perspective view of the cutting links 640 of FIG. 17A. FIG. 17C shows a side view of three cutting links 640 coupled together with the cutting links 640 pivoted or articulated with respect to each other, with phantom lines to show internal/hidden features of the links. When coupled, each link 640 is pivotable about a pivot axis 699.

As can be seen in FIGS. 16A through 17C, each of the cutting links 640 has a fin 670 and a pocket 672. The fin 670 in this example is a narrowed structure, in this case a narrowed end portion of the rounded feature or projection 654. The groove 655 in the link 640 for accommodating the rail of the saw bar may bisect the fin 670 and separate the fin 670 into two parts. The pocket 672 is formed by an extension or wall 673 extending from the hook 650 on each lateral side of the hook 650. The walls 673 are located on the side of the hook 650 that faces the rounded feature or projection 654 of an adjacent link 640 when links are coupled. The pocket 672 serves as a channel within which the fin 670 of an adjacent, coupled link may be retained during use of the chain of links 640. When links 640 are coupled as shown in FIGS. 17A-17C, the fin 670 of one link 640 is positioned in the pocket 672, between the walls 673, of an adjacent link 640.

When the cutting links 640 are assembled together as shown in FIGS. 17A-C, the fin 670 within the corresponding pocket 672 helps resist lateral dislocation or separation of the links 640 from each other. In other words, movement of one link 640 relative to the adjacent coupled link 640 in the lateral direction is resisted. The resistance of such lateral dislocation is facilitated by the overlap of the two coupled links at the area of the fin 670 when viewed laterally (i.e., from the side, as shown in FIG. 17C). As can be seen in FIG. 17C, when viewed laterally, a significant portion (or in some embodiments all) of the fin 670 overlaps with the side walls on each side of the pocket 672 (i.e., the sides of walls 673) of the adjacent link 640. The side walls of the pocket 672 (i.e., the sides of walls 673) resist movement of the fin 670 in the lateral direction. Similarly, the fin 670 resists movement of the side walls of the pocket 672 (i.e., the sides of walls 673) in the lateral direction. Thus, the fin 670 together with the side walls of the pocket 672 resist movement of the coupled links 640 with respect to each other in the lateral direction.

In the example shown in FIGS. 16A through 17C, each cutting tooth 660 is in the form of a single flat chip tooth cutter. The teeth may be along one side of the chain or may alternate or may be in any other suitable arrangement. As can be seen, in this embodiment, the tooth faces to the opposite end of the link 640 than the hook 650. Where suitable, the teeth in any embodiment may face the opposite direction or in multiple directions, and the chain may be operated in either direction.

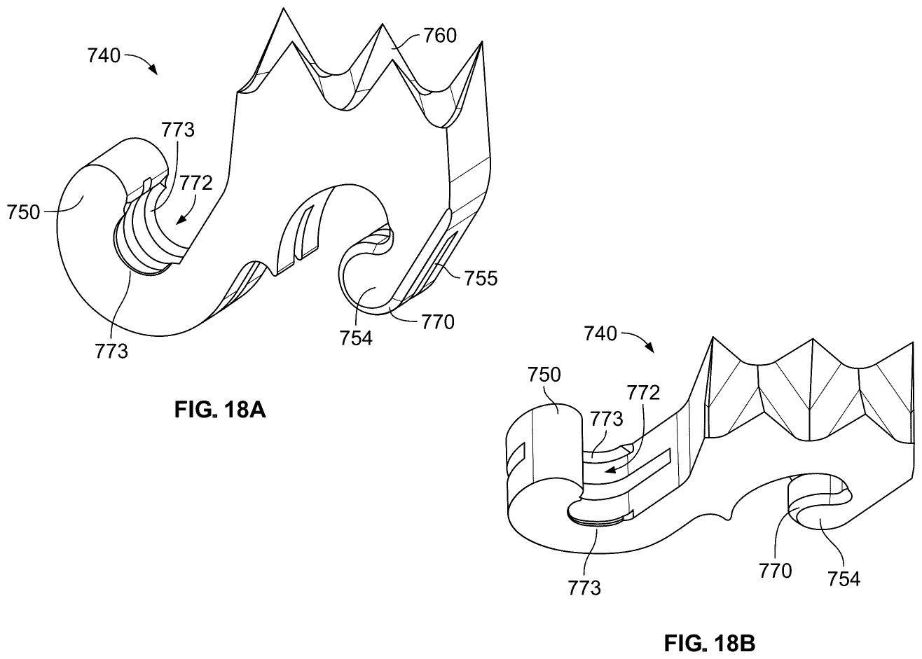

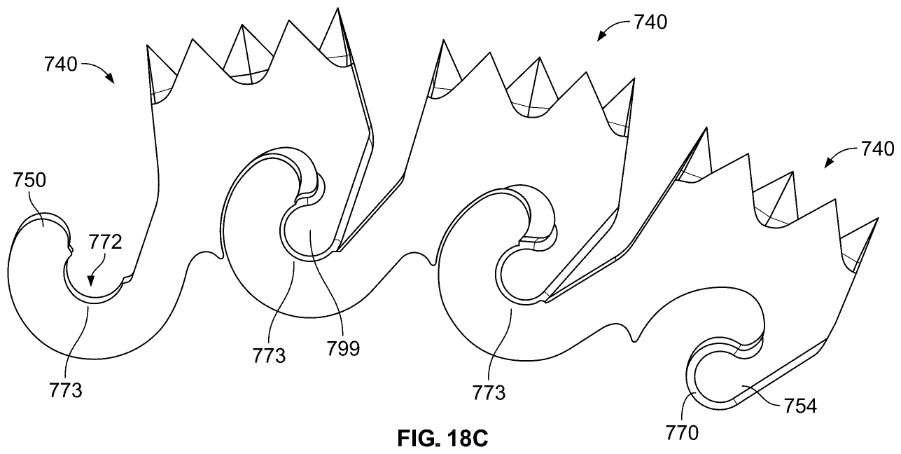

FIGS. 18A through 18C illustrate further examples of cutting links 740. FIG. 18A shows a perspective view of an example cutting link 740, generally showing the second lateral side and first adjacent link side. FIG. 18B shows another perspective view of a cutting link 740, generally showing the top side, second adjacent link side, and second lateral side. FIG. 18C shows a side view of three cutting links 740 coupled together with the cutting links 740 pivoted or articulated with respect to each other. When coupled, each link 740 is pivotable about a pivot axis 799.

As can be seen in FIGS. 18A through 18C, each of the cutting links 740 has a fin 770 and a pocket 772. The fin 770 in this example is a narrowed structure, in this case formed by a chamfered edge of the rounded feature or projection 754. The groove 755 in the link 740 for accommodating the rail of the saw bar may bisect the fin 770 and separate the fin 770 into two parts. The pocket 772 is formed by an extension or wall 773 on or extending from the hook 750 on each lateral side of the hook 750. The walls 773 are located on the side of the hook 750 that faces the rounded feature or projection 754 of an adjacent link 740 when links are coupled. The pocket 772 serves as a channel within which the fin 770 of an adjacent, coupled link may be retained during use of the chain of links 740. When links 740 are coupled as shown in FIG. 18C, the fin 770 of one link 740 is positioned in the pocket 772, between the walls 773, of an adjacent link 740.

When the cutting links 740 are assembled together as shown in FIG. 18C, the fin 770 within the corresponding pocket 772 helps resist lateral dislocation or separation of the links 740 from each other. In other words, movement of one link 740 relative to the adjacent coupled link 740 in the lateral direction is resisted. The resistance of such lateral dislocation is facilitated by the overlap of the two coupled links at the area of the fin 770 when viewed laterally (i.e., from the side, as shown in FIG. 18C). As can be seen in FIG. 18C, when viewed laterally, a significant portion (or in some embodiments all) of the fin 770 overlaps with the side walls on each side of the pocket 772 (i.e., the sides of walls 773) of the adjacent link 740. The side walls of the pocket 772 (i.e., the sides of walls 773) resist movement of the fin 770 in the lateral direction. Similarly, the fin 770 resists movement of the side walls of the pocket 772 (i.e., the sides of walls 773) in the lateral direction. Thus, the fin 770 together with the side walls of the pocket 772 resist movement of the coupled links 740 with respect to each other in the lateral direction.

In the example shown in FIGS. 18A through 18C, each cutting tooth 760 is in the form of a pyramid. The teeth may be along one side of the chain or may alternate or may be in any other suitable arrangement.

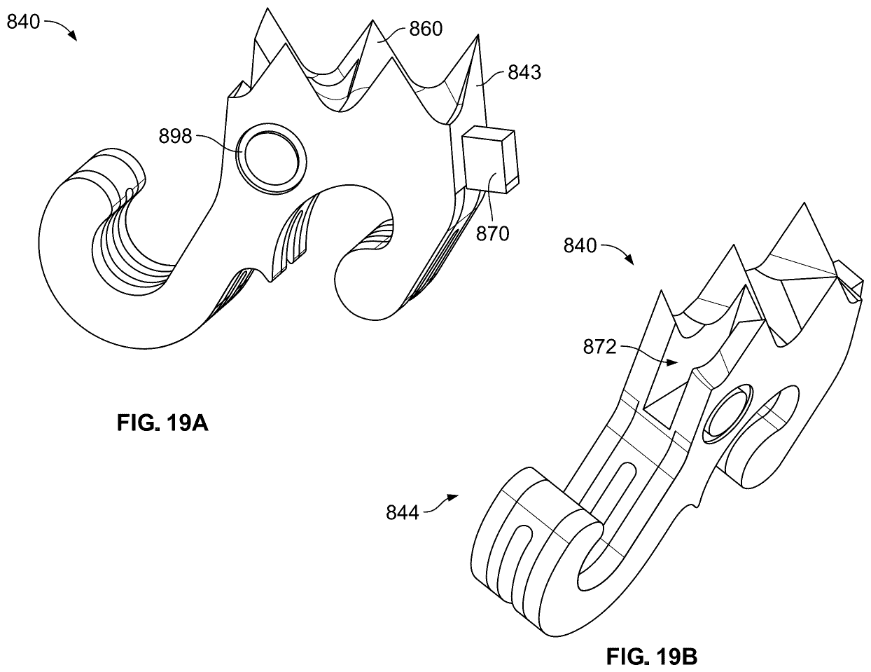

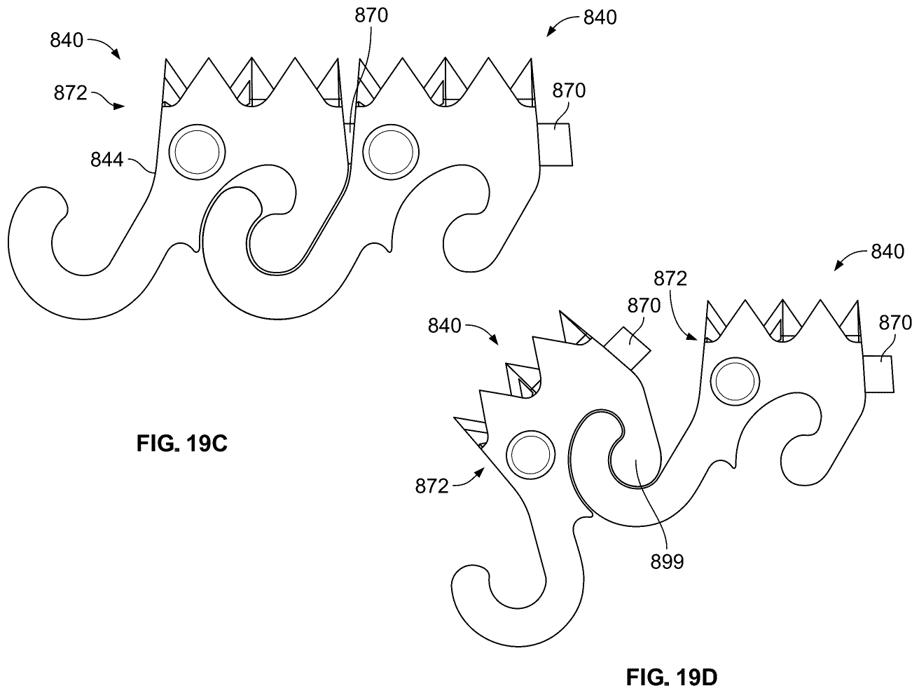

FIGS. 19A through 19D illustrate further examples of cutting links 840. FIG. 19A shows a perspective view of an example cutting link 840, generally showing the second lateral side and first adjacent link side. FIG. 19B shows another perspective view of a cutting link 840, generally showing the second adjacent link side and second lateral side. FIG. 19C shows a side view of two cutting links 840 coupled together and aligned longitudinally with respect to each other. FIG. 19D shows a side view of two cutting links 840 coupled together with one cutting link 840 pivoted or articulated with respect to the other cutting link 840. When coupled, each link 840 is pivotable about a pivot axis 899.

As can be seen in FIGS. 19A through 19D, each of the cutting links 840 has a fin or extension 870 and a pocket 872. The fin or extension 870 in this embodiment extends from the first adjacent link side 843 of the link 840. The illustrated fin 870 is block-shaped with a rectangular cross-section and straight sides. However, many other shapes are possible, including curved and irregular shapes. The pocket 872 comprises a groove or channel extending inwardly from the second adjacent link side 844 of the link 840 and open at the top. The pocket 872 serves as a channel within which the fin or extension 870 of an adjacent, coupled link may be positioned during use of the chain of links 840.

When the cutting links 840 are assembled together as shown in FIG. 19C, the fin 870 within the corresponding pocket 872 helps resist lateral dislocation or separation of the links 840 from each other. In other words, movement of one link 840 relative to the adjacent coupled link 840 in the lateral direction is resisted. The resistance of such lateral dislocation is facilitated by the overlap of the two coupled links at the area of the fin 870 when viewed laterally (i.e., from the side, as shown in FIG. 19C). As can be seen in FIG. 19C, when viewed laterally, a significant portion (or in some embodiments all) of the fin 870 overlaps with the side walls on each side of the pocket 872 of the adjacent link 840. The side walls of the pocket 872 resist movement of the fin 870 in the lateral direction. Similarly, the fin 870 resists movement of the side walls of the 872 in the lateral direction. Thus, the fin 870 together with the side walls of the pocket 872 resist movement of the coupled links 840 with respect to each other in the lateral direction.

As can be seen in FIGS. 19C-D, at a certain angle of pivot, in this embodiment, the fin 870 can swing out of the pocket 872, and the fin 870 can swing back into the pocket 872 when pivoted back toward longitudinal alignment. With suitable design of the fin and pocket, the links can be designed such that: (i) the fin cannot move out of the pocket unless the adjacent links are pivoted beyond all angles of ordinary use of the chain around the saw bar and the links are moved laterally with respect to each other (e.g., FIGS. 2A-5D), (ii) the fin can move out of the pocket only if the adjacent links are pivoted to an angle (or angles) of ordinary use of the chain around the saw bar (or, in some embodiments, aligned) and the links are moved laterally with respect to each other (e.g., certain modified versions of FIGS. 2A-5D), (iii) the fin can pivot out of the pocket only if the adjacent links are pivoted beyond all angles of ordinary use of the chain around the saw bar, but without the need for lateral movement to separate the links (e.g., certain modified versions of FIGS. 19A-19D), or (iv) the fin can pivot out of the pocket and back into the pocket during angles of ordinary use of the chain around the saw bar, without the need for lateral movement to separate the links (e.g., certain other versions of FIGS. 19A-19D).

In the example shown in FIGS. 19A through 19D, each cutting tooth 860 is in the form of a single pyramid chip tooth cutter. The teeth may be along one side of the chain or may alternate or may be in any other suitable arrangement. (FIGS. 19A-D also show rings 898 indicating the ejector pad locations for a metal injection molding manufacturing process.)

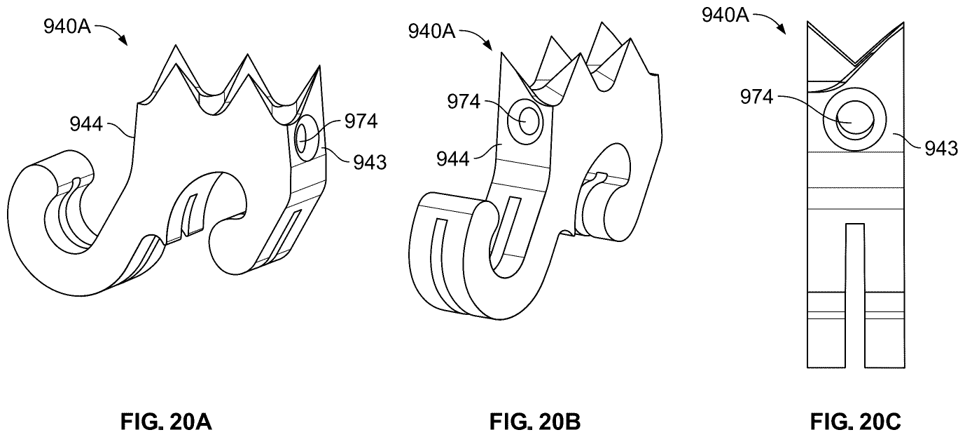

FIGS. 20A-20C show another embodiment of cutting links 940A. Each link 940A has a hole 974 extending through the link 940A in the longitudinal direction. The hole 974 extends from an open end on the first adjacent link side 943 to an open end on the second adjacent link side 944. A continuous wire, thread, etc., may be threaded through holes 974 in a series of links 940A to hold the linkage together and inhibit dislocation of the links. The wire, thread, etc., may pass as a continuous loop through all of the links 940A in a chain of links 940A.

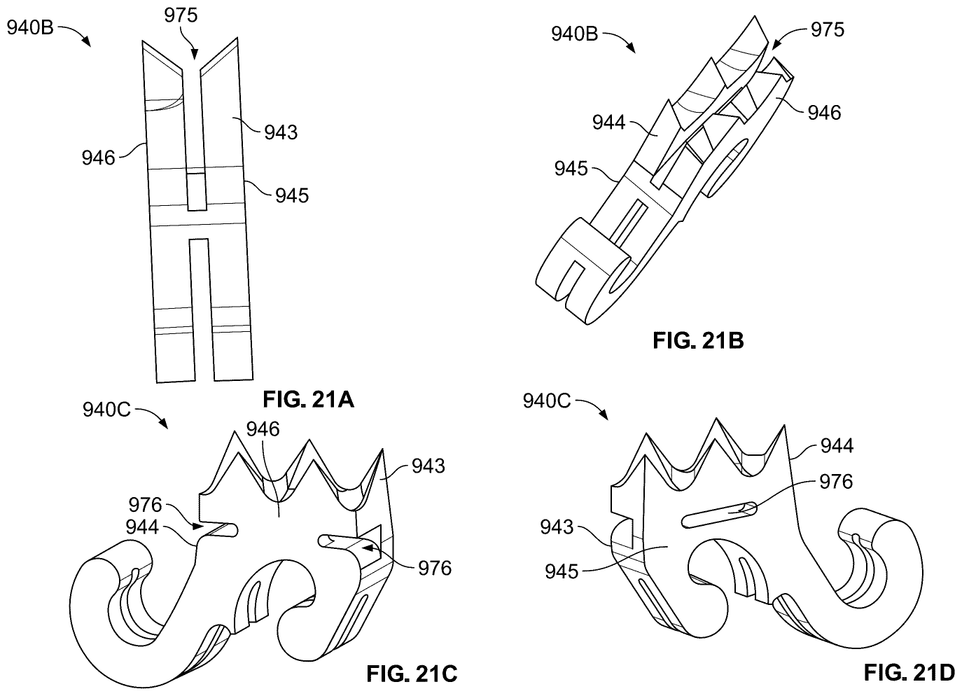

As shown in FIGS. 21A and 21B, alternatively, instead of a hole 974, an open-ended slot or channel 975 may be provided in the links 940B in the longitudinal direction. The channel 975 extends from the first adjacent link side 943 to the second adjacent link side 944. As with the links 940A, a continuous wire, thread, etc., may be threaded through channels 975 in a series of links 940B to hold the linkage together and inhibit dislocation of the links. The wire, thread, etc., may pass as a continuous loop through all of the links 940B in a chain of links 940B.

As shown in the cutting links 940C of FIGS. 21C and 21D, as an alternative way to make a hole or bore through the links, slots or openings 976 may be provided in the first lateral side 945 and second lateral side 946 of the links 940C. The openings 976 may alternate sides of the links and may overlap, resulting in a continuous bore extending from an open end on the first adjacent link side 943 to an open end on the second adjacent link side 944. Any suitable number of slots or openings 976 may be provided. A wire, thread, etc., may be placed through the bore in a similar manner as with links 940A and 940B. The version of FIGS. 21C-D may be useful for manufacturing, as in the case of molded links it can avoid the need for a side action tool to create the hole through the links.

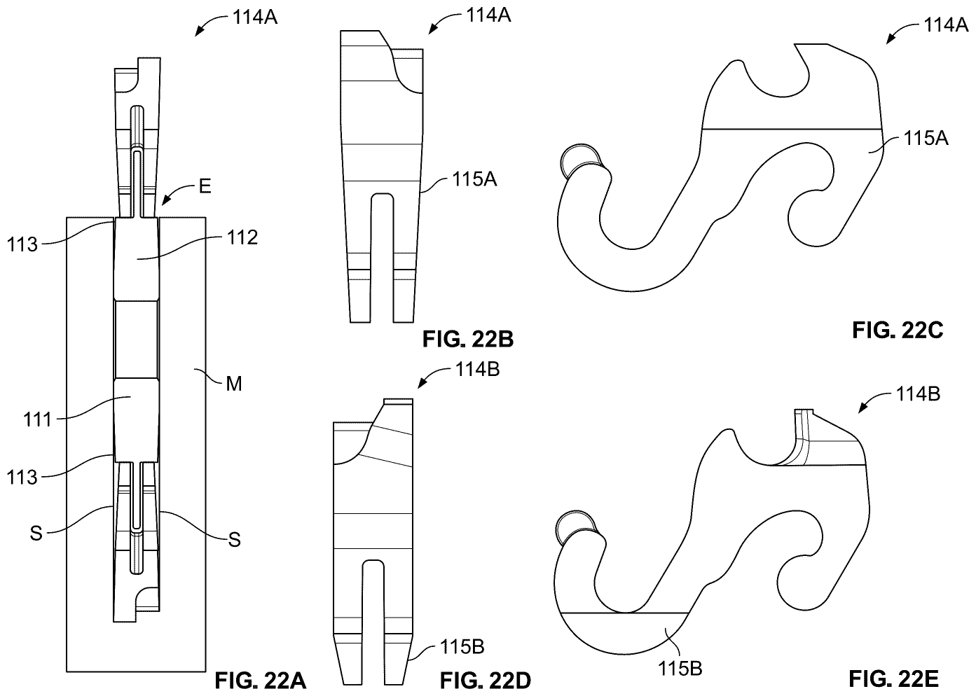

FIGS. 22A-22E show further examples of chain saws and cutting link configurations. FIG. 22A shows a saw bar 111 with a chain of links 114A cutting through a material M.

In some instances, when a chain saw is cutting through material, there could be a tendency for the back side of the chain (the trailing side) to catch at its edge E when cutting through material. In addition, there could be drag on the chain links as they slide against the material on either side S of the cut. This could lead to several issues, such as increased pull force on the links, potential tripping of the clutch, friction, heat generation, etc.

To reduce the potential for such issues, as shown in FIGS. 22B and 22C, cutting links 114A are tapered such that the bottom parts of the links 114A are narrower than the top parts (cutting sides) of the links. The links 114A have tapered bodies 115A. This tapering means that the width of the links 114A at the lower edge E is narrower than the width of the links 114A at the top, i.e., at the location of the cutting teeth. Thus, the width of the links 114A at the lower edge E is narrower than the width of the cut area through the material. This tapering reduces the tendency for the back side of the chain (the trailing side) to catch at its lower edge E when cutting through material and facilitates feeding the back side of the chain into the cut groove. In addition, the tapered area reduces the drag on the chain links as they cut through the material on either side S of the cut.

FIGS. 22D and 22E show an alternative embodiment of cutting links 114B. The links 114B have tapered lower ends 115B, with a shorter height of tapering than the links 114A. This tapering provides some or all of the advantages mentioned above with respect to the links 114A, while maintaining more material in the link body. The cutting links 40A, 40B in FIGS. 2A-5D have tapered lower ends 15 similar to the tapered lower ends 115B of the links 114B in FIGS. 22D-22E.

FIG. 22A also shows a tapering of the saw bar 111. The edge 113 of the saw body 112 of the saw bar 111 is tapered or narrowed as compared to the interior part of the saw body 112. This tapering can reduce dragging and load. This tapering can also help avoid catching of the saw bar on the material as it enters the cut.

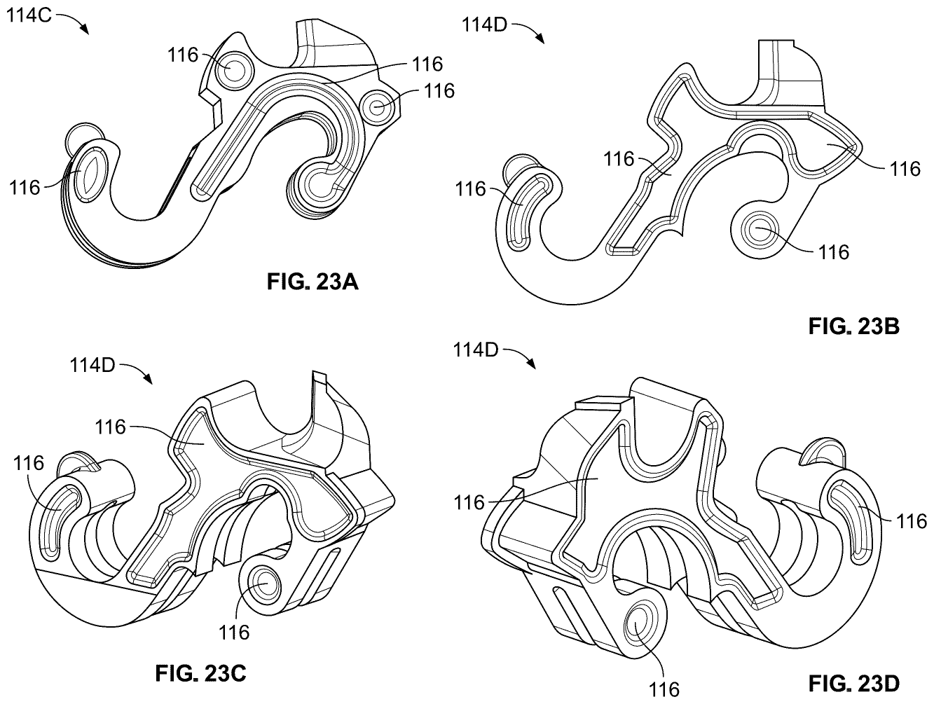

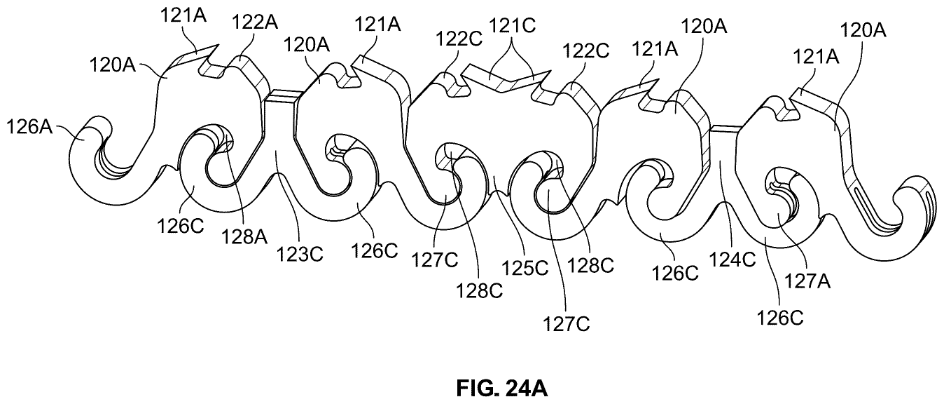

FIGS. 23A through 23D show cutting links 114C and 114D with recesses 116 on the lateral sides of the links. These recesses 116 reduce the link surface contact with the material M on either side S of the cut while cutting, with the links still having sufficient material at the lateral side surfaces for link alignment. The recessed areas 116 reduce surface area contact with the material being cut, which can reduce friction, heat, power draw, etc.

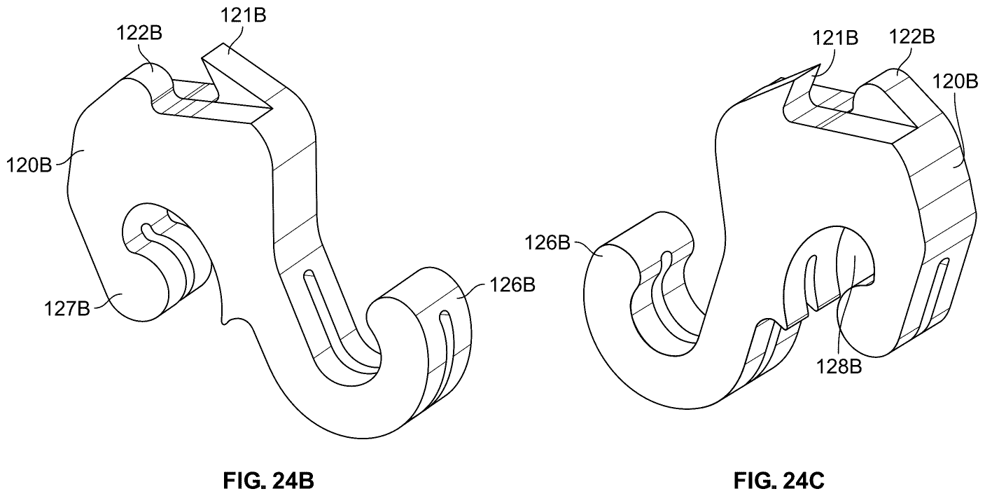

FIG. 24A shows a chain having cutting links 120A. The cutting links 120A have hooks 126A, rounded features or projections 127A, and recesses 128A, similar to embodiments described above. The cutting links 120A have cutting teeth 121A and depth limiters 122A, which limit the depth of the cutting teeth of the chain into the material being cut. In the cutting links 120A, the teeth generally point toward the side of the link 120A with the hook 126A (although teeth in any direction and multiple directions are possible).

The chain in FIG. 24A also includes spacer links 123C, 124C, and 125C. The spacer links 123C, 124C are double-hook links, having a hook 126C on each adjacent link side. The spacer link 125C is a double-recess link, having a recess 128C and rounded feature or projection 127C on each adjacent link side. The double-hook spacer links 123C, 124C can couple with the recesses of adjacent links, causing the orientation of the cutting links 120A in the chain to reverse direction. Similarly, the double-recess spacer links 125C can couple with the hooks of adjacent links, causing the orientation of the cutting links 120A in the chain to reverse direction. The spacer links 123C, 124C, and 125C may or may not have cutting teeth 121C (and depth limiters 122C).

FIGS. 24B and 24C show opposite lateral sides of a cutting link 120B. Cutting links 120B have hooks 126B, rounded features or projections 127B, and recesses 128B, similar to embodiments described above. The cutting links 120B also have cutting teeth 121B and depth limiters 122B. In the example of FIGS. 24B and 24C, the depth limiter 122B and cutting tooth 121B in a cutting link 120B are laterally offset from each other. This arrangement can facilitate cutting efficiency, helping to clear out cut material from the cutting links 120B.

FIGS. 25A-25D show another embodiment of two coupled cutting links 1040. The cutting links 1040 are similar in all respects to the cutting links 40 except for the features described below in the area of the gate 1090 (the links 1040 as illustrated in FIGS. 25A-25D correspond to cutting links 40A, but similar links 1040 may be provided corresponding to cutting links 40B). Like the cutting links 40, the cutting links 1040 cannot be assembled together while both links are in the same x-y plane, due to the geometry of the links. In order to couple together the cutting links 1040, each cutting link 1040 has a gate 1090 located on one of its lateral sides. Similar to the way in which the gate 90 is a space in one of the side walls of the hook extension pocket 72 (FIGS. 5A and 5B), the gate 1090 is a space in one of the side walls of the hook extension pocket 1072. Like the gate 90, the gate 1090 is sized and shaped to allow the fin or hook extension 1070 (similar to fin or hook extension 70) to be passed laterally through the gate 1090 so that the fin or hook extension 1070 can be positioned into, and removed from, the hook extension pocket 1072. In order to assemble links 1040, the two links 1040 are positioned in parallel planes, laterally displaced from one another, and angled (pivoted) with respect to each other so that the fin or hook extension 1070 of one link is aligned with and next to the gate 1090 of the other link (the relative angular positions as shown in FIG. 25B). Then, for assembly, the links 1040 are moved into lateral alignment to move the fin or hook extension 1070 laterally through the gate 1090 and into the hook extension pocket 1072. The fin 1070 passes through the gate 1090, with the links still in parallel planes, until the links are coplanar, with the fin 1070 positioned in the pocket 1072. When the relative angle (pivot angle) between the links is decreased, the fin 1070 is captive by the pocket 1072 of the adjacent link.

Similar to the links 40 described above, the angle at which the links 1040 must be positioned with respect to each other for assembly may be out of the range of angles that the links 1040 pivot through during normal use of the chain saw. That is, the cutting links 1040 may be designed such that, during normal use of the chain saw, the cutting links 1040 do not pivot enough to move the fins or hook extensions 1070 into alignment with the gates 1090. Thus, the geometry helps avoid decoupling of the links 1040 from each other during normal operation of the chain saw.

As an additional guard against unintentional decoupling (or, in some embodiments, as an alternative guard against unintentional decoupling), the links 1040 may have a closure or flap to close the gate 1090 after the cutting links 1040 are coupled, to inhibit the fins or hook extensions 1070 from passing through the gates 1090 during use. In the example of FIGS. 25A-25D, one or more ribs 1092 is/are provided adjacent the gate 1090. When the links 1070 are manufactured, the ribs 1092 are in a first, open position. The material of the ribs 1092 is clear of the access opening of the gate 1090 to allow the fin or hook extension 1070 of the connecting link 1040 to pass through. Once the connecting link is installed, with the fin or hook extension 1070 passed through the gate 1090, the ribs 1092 may be crushed or permanently deformed such that the deformed material of the ribs 1092 moves into the gate opening, thereby blocking the fin or hook extension 1070 from passing back out of the gate 1090. This inhibits or prevents the connecting link from being able to disengage. A recess or pocket 1094 may be provided adjacent the gate 1090 in the lateral side of the link 1070, with the pocket 1094 surrounding or adjacent the ribs 1092 to allow for excess material from the deformation of the ribs 1092 to flow into the pocket 1094 as opposed to resting proud on the side of the link. This allows for the lateral side of the link 1040 to maintain its flatness even after the permanent deformation of the ribs 1092.

In one example, the link 1070 is manufactured of a metallic material and the ribs 1092 have a geometry such that they may be permanently (plastically) deformed by a tool acting against the side of the link 1070. Once the hook extension or fin 1070 of one link is passed through a gate 1090 of the adjacent link, the tool is used to press against the ribs 1092 on the side of the link 1040 to reshape the ribs 1092.

Once deformed, the ribs 1092 are in a second, closed position. The deformed ribs 1092 prevent the fin or hook extension 1070 from passing back out of the gate 1090, and, in this manner, the deformed ribs 1092 keep the connected links 1040 locked captive together. Once the links 1040 are assembled together with the ribs 1092 deformed, the links 1040 are inhibited or prevented from unintentionally decoupling.

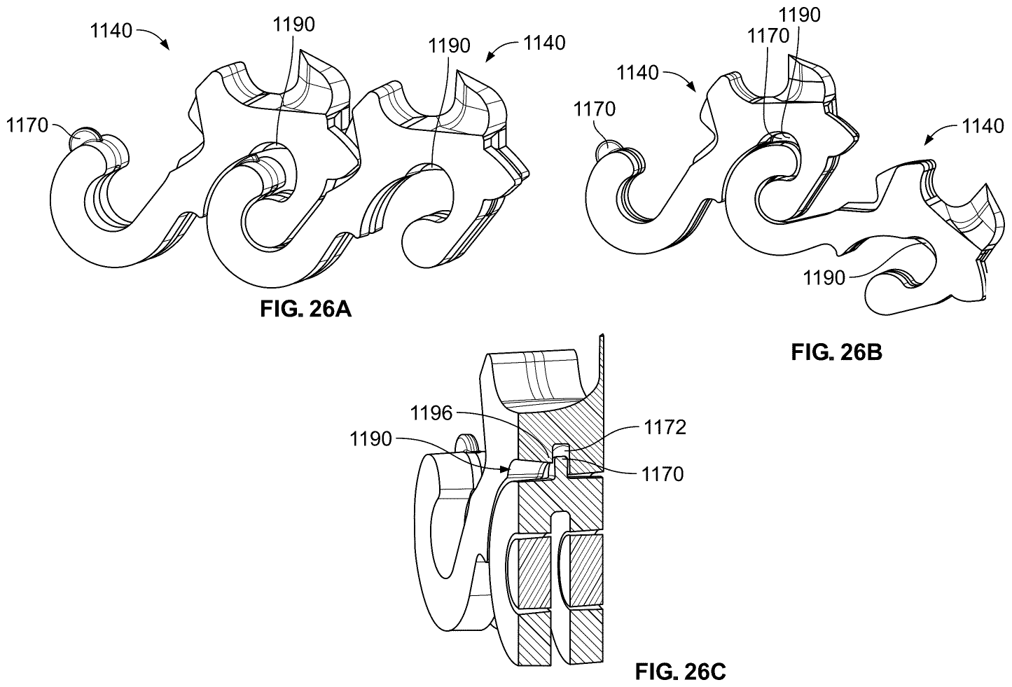

FIGS. 26A-26C show another embodiment of two coupled cutting links 1140. The cutting links 1140 are similar in all respects to the cutting links 40 except for the features described below in the area of the gate 1190 (the links 1140 as illustrated in FIGS. 26A-26C correspond to cutting links 40A, but similar links 1140 may be provided corresponding to cutting links 40B). Like the cutting links 40, the cutting links 1140 cannot be assembled together while both links are in the same x-y plane, due to the geometry of the links. In order to couple together the cutting links 1140, each cutting link 1140 has a gate 1190 located on one of its lateral sides. Similar to the way in which the gate 90 is a space in one of the side walls of the hook extension pocket 72 (FIGS. 5A and 5B), the gate 1190 is a space in one of the side walls of the hook extension pocket 1172. Like the gate 90, the gate 1190 is sized and shaped to allow the fin or hook extension 1170 (similar to fin or hook extension 70) to be passed laterally through the gate 1190 so that the fin or hook extension 1170 can be positioned into the hook extension pocket 1172. In order to assemble links 1140, the two links 1140 are positioned in parallel planes, laterally displaced from one another, and angled (pivoted) with respect to each other so that the fin or hook extension 1170 of one link is aligned with and next to the gate 1190 of the other link (the relative angular positions as shown in FIG. 26B). Then, for assembly, the links 1140 are moved into lateral alignment to move the fin or hook extension 1170 laterally through the gate 1190 and into the hook extension pocket 1172. The fin 1170 passes through the gate 1190, with the links still in parallel planes, until the links are coplanar, with the fin 1170 positioned in the pocket 1172.

Similar to the links 40 described above, the angle at which the links 1140 must be positioned with respect to each other for assembly may be out of the range of angles that the links 1140 pivot through during normal use of the chain saw. That is, the cutting links 1140 may be designed such that, during normal use of the chain saw, the cutting links 1140 do not pivot enough to move the fins or hook extensions 1170 into alignment with the gates 1190. Thus, the geometry helps avoid decoupling of the links 1140 from each other during normal operation of the chain saw.

As an additional guard against unintentional decoupling (or, in some embodiments, as an alternative guard against unintentional decoupling), the links 1140 have a snap connection as the hook extension or fin 1170 of one link is positioned through the gate 1190 and into the hook extension pocket 1172 of an adjacent link. In one example, a retention ledge 1196 at the gate 1190 is designed as a snap-fit counterpart to the hook extension or fin 1170 of the adjacent link. In the illustrated example, the retention ledge 1196 is tapered toward, or narrows toward, the hook extension pocket 1172. At its narrower region by the hook extension pocket 1172, the retention ledge 1196 is designed to interfere with the hook extension or fin 1170 such that the connecting links cannot fully connect without forcing the hook extension or fin 1170 past the retention ledge 1196 with a snap-fit. Local elastic deformation and/or flexing of the mating links (at the hook extension or fin 1170 and/or at the retention ledge 1196) allows the hook extension or fin 1170 to snap past the narrowest part of the retention ledge 1196 and into the hook extension pocket 1172. The taper of the retention ledge 1196 in the direction of assembly provides mechanical advantage to this installation process. Once the mating link has passed the interference of the retention ledge 1196, the retention ledge 1196 blocks movement of the hook extension or fin 1170 in the reverse direction back out of the gate 1190. This inhibits or prevents the connecting link from being able to disengage.

In one example, the link 1070 is manufactured of a metallic material and the snap-fit parts (the hook extension or fin 1170 and/or the retention ledge 1196) have a geometry such that one or more of them may be flexed or elastically deformed, e.g., by a tool acting against the side of the link 1170. The tool is used to press the hook extension or fin 1170 of one link through a gate 1190 of the adjacent link, past the retention ledge 1196 and into the hook extension pocket 1172.

The snap-fit (e.g., of the retention ledge 1196) prevents the fin or hook extension 1170 from passing back out of the gate 1190, and, in this manner, the snap-fit keeps the connected links 1140 locked captive together. Once the links 1140 are assembled together with the snap-fit, the links 1140 are inhibited or prevented from unintentionally decoupling.

As mentioned above, the cutting links 1040 as illustrated in FIGS. 25A-25D and the cutting links 1140 as illustrated in FIGS. 26A-26C correspond to the cutting links 40A except for the features described above in the area of the gates 1090, 1190. As also mentioned above, the cutting links 1040 and the cutting links 1140 may be designed to correspond to the cutting links 40B except for the features described above in the area of the gates 1090, 1190. In the illustrated embodiments, the gates 1090, 1190 are on the same lateral sides of adjacent cutting links. When the links 1040, 1140 in a chain or chain segment have their gates 1090, 1190 on the same lateral sides, all or several of the links may be assembled together at once by pressing with a tool from that lateral side (e.g., to pass the hook extensions or fins through the gates and/or to deform ribs). In alternative embodiments, the gates may be on both sides of the cutting links (e.g., all the way through the cutting links). The deformable ribs 1092 and/or snap-fit (e.g., retention ledges 1196) may be provided on both sides of the hook extension pocket 1072, 1172. In other alternative embodiments, alternating link configurations may be used in which links with gates on the first lateral side alternate with links with gates on the second lateral side, similar to the configuration shown in FIG. 4A. When the gates are on opposite sides of a chain or chain segment, all or several of the links may be assembled together at once by pressing with a tool from both lateral sides (e.g., to pass the hook extensions or fins through the gates and/or to deform ribs).

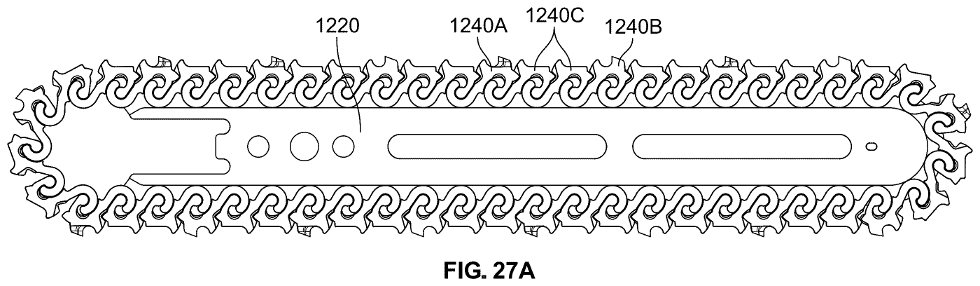

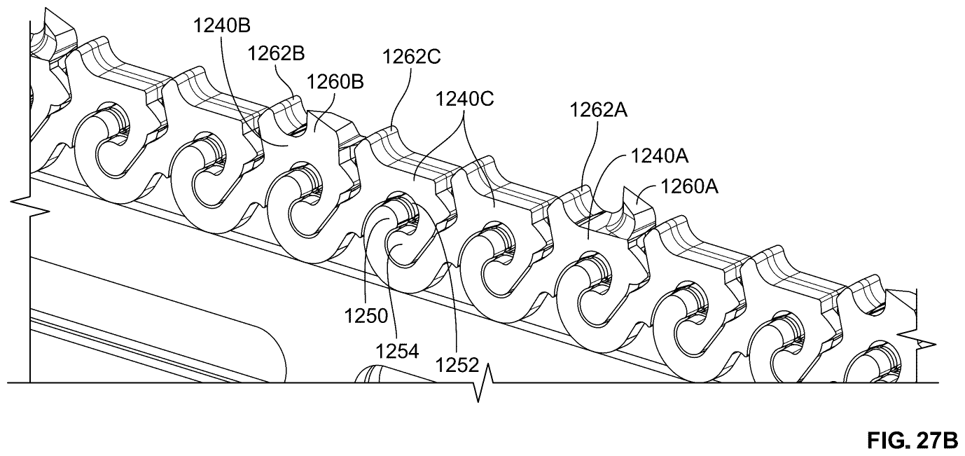

FIGS. 27A and 27B show another embodiment of a chain of cutting links arranged around a saw bar 1220. The chain of cutting links includes cutting links and spacer links. In the illustrated embodiment, the chain has first cutting links 1240A and second cutting links 1240B. Each first cutting link 1240A has one or more cutting teeth 1260A (one in the illustrated example) positioned on the first lateral side of the cutting link 1240A, while each second cutting link 1240B has one or more cutting teeth 1260B (one in the illustrated example) positioned on the second lateral side of the cutting link 1240B. The first cutting links 1240A and the second cutting links 1240B may be referred to as left cutters and right cutters, respectively (or vice versa, depending upon the orientation). In alternative variations, the cutting links may have any number and configuration of cutting teeth. The cutting links may have depth limiters 1262A, 1262B, which limit the depth of the cutting teeth of the chain into the material being cut.

The spacer links 1240C are similar to the cutting links 1240A, 1240B, except that the spacer links 1240C do not have cutting teeth. In alternative variations, the spacer links may have cutting teeth that differ from the cutting teeth of the other links in the chain; for example, the spacer links may have smaller cutting teeth than the other links in the chain. The spacer links may have depth limiters 1262C. In the illustrated embodiment, the spacer links 1240C have depth limiters 1262C and no cutting teeth. The spacer links 1240C may be referred to as blanks.

The links 1240A, 1240B, 1240C may be similar in some or all respects to the cutting links 60A, 60B, or to any of the other links described herein (except that the spacer links 1240C do not have cutting teeth). In the illustrated example, the links 1240A, 1240B, 1240C have hooks 1250, recesses 1252, and rounded features or projections 1254, similar in structure and function as the hooks, recesses, and rounded features or projections as described above. The links may have grooves for fitting the links over a rail of the saw bar, as described above. The links may have fins, pockets, protruding tabs, sockets, and/or gates, as well as other features, similar to those described above.

In a chain of connected links, singles or multiples of cutting links may alternate with singles or multiples of spacer links. In the illustrated embodiment, the pattern is a left cutter 1240A, followed by two blanks 1240C, followed by a right cutter 1240B, followed by two blanks 1240C, and then repeating this sequence. In certain applications, such an arrangement can increase the efficiency for the cutting of the material since the spacer links (blanks) allow for the clearance of chips or debris faster and/or result in increased pressure on the cutting links for a given force (fewer cutting teeth in the chain means less cutting area so the pressure is higher). Such an arrangement is also relatively simple for manufacture/assembly. Many other arrangements are possible (e.g., left cutter-blank-right cutter-blank; left cutter-right cutter-blank-blank; left cutter-blank-blank-left cutter-blank-blank-right cutter-blank-blank-right cutter blank-blank; etc.). The arrangement can be tailored to the characteristics desired for the intended application.

Components as disclosed herein may be made out of any suitable material, e.g., stainless steel, plastic, steel, other suitable metals, etc. Components as disclosed herein may have any suitable dimensions. As one of many possible examples, links as disclosed herein may have a width of 2 mm.

Components as disclosed herein may be manufactured in any suitable manner. For example, the links may be manufactured by direct metal laser sintering, CNC machining, plastic injection molding, or by metal injection molding. In some examples, the links may be manufactured using: (i) metal injection molding to mold a link having a first lateral side, a second lateral side, and a plurality of cutting teeth, and (ii) grinding (e.g., double disc grinding) to grind the first lateral side and the second lateral side of the link.

In some examples, a hard coating may be applied to the saw bar, to the links, to the contact surface of the saw bar, i.e., the surface of the saw bar that contacts the links, and/or to the contact surface of the links, i.e., the surface of the links that contacts the saw bar. The hard coating reduces friction and heat generation. The hard coating may also reduce wear and can avoid the need for lubricants.

Chain saws, and other tools and devices incorporating cutting chains, and cutting links as disclosed herein can achieve one or more advantages, such as: reduced number of tools needed, lower cost, easier use, easier storage, easier transportation, less failure, more precise cuts, lower work time, and/or better outcomes.

Persons of ordinary skill in the art will appreciate that the embodiments encompassed by the disclosure are not limited to the example embodiments illustrated in the drawings or described above. While illustrative embodiments have been shown and described, a wide range of modifications, changes, and substitutions is contemplated in the foregoing disclosure. It is understood that such variations may be made to the foregoing without departing from the scope of the disclosure.

What is claimed is:

1. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein the plurality of links further comprises a fin located at one of a surface of the hook or a surface of the recess and a pocket located at the other of the surface of the hook and the surface of the recess, wherein the fin is adapted to be positioned in the pocket; and
wherein the plurality of links further comprises a gate adapted to permit the fin to pass through the gate in a lateral direction, thereby enabling the first link and the second link to be coupled by lateral movement between the first link and the second link.

2. The device as recited in claim 1, wherein the gate is located on a side of the pocket.

3. The device as recited in claim 2, wherein the gate is located on only one side of the pocket.

4. The device as recited in claim 1, wherein the plurality of links further comprises one or more closures for closing the gate after the fin is passed through the gate in a lateral direction.

5. The device as recited in claim 4, wherein the one or more closures comprises one or more deformable ribs.

6. The device as recited in claim 1, wherein the plurality of links further comprises a snap-fit for retention of the fin in the pocket after the fin is passed through the gate in a lateral direction.

7. The device as recited in claim 6, wherein the snap-fit comprises a retention ledge adjacent the gate opening.

8. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein the plurality of links further comprises a fin located at one of an outer surface of the hook or an outer surface of the recess and a pocket located at the other of the outer surface of the hook and the outer surface of the recess, wherein the fin is adapted to be positioned in the pocket.

9. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein the plurality of links further comprises a fin located at an inner surface of the hook of the first link and a pocket located at an outer surface of a rounded projection of the second link.

10. The device as recited in claim 9, wherein the pocket located at the outer surface of the rounded projection of the second link is defined by projections on each lateral side of the pocket.

11. The device as recited in claim 10, wherein the projections are partial disks.

12. The device as recited in claim 10, wherein the projections are wedges.

13. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein the plurality of links further comprises a pocket located on an inner surface of the hook of the first link and a fin comprising one of a narrow rounded projection of the second link or a rounded projection of the second link with chamfered edges.

14. A device incorporating a cutting chain comprising:
a bar; and
a plurality of links arranged in a chain along a chain path around the bar;
wherein a first link comprises one or more cutting teeth positioned along a first lateral side of the first link with no cutting teeth positioned along a second lateral side of the first link, and the second link comprises one or more cutting teeth positioned along a second lateral side of the second link with no cutting teeth positioned along a first lateral side of the second link.

15. A device incorporating a cutting chain comprising:
a bar; and
a plurality of links arranged in a chain along a chain path around the bar;
wherein a first link comprises a protruding tab extending from a first adjacent link side of the first link, and the second link comprises an indented socket in a second adjacent link side of the second link;
wherein the protruding tab of the first link is adapted to be positioned in the indented socket of the second link when the first link and the second link are longitudinally aligned.

16. The device as recited in claim 15, wherein the protruding tab of the first link is adapted to be positioned out of the indented socket of the second link when the first link and the second link are pivoted with respect to each other.

17. The device as recited in claim 16, wherein the protruding tab has an outer surface along a curved arc segment and the indented socket has an outer surface along a corresponding curved arc segment.

18. The device as recited in claim 16, wherein the protruding tab comprises a body portion and a lip portion and the indented socket comprises a body recess and a lip recess.

19. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar; and
wherein each link in the plurality of links comprises a hole or channel extending from a first adjacent link side to a second adjacent link side and adapted to receive a thread or wire.

20. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein each of the first link and the second link is tapered along at least part of its height so that a bottom of the link is narrower than a top of the link.

21. The device as recited in claim 20, wherein each of the first link and the second link has a tapered body.

22. The device as recited in claim 20, wherein each of the first link and the second link has a tapered lower end.

23. A device incorporating a cutting chain comprising:
a bar; and
a plurality of links arranged in a chain along a chain path around the bar;
wherein a first link comprises a hook that engages a recess of a second link, thereby coupling the first link and the second link and allowing the first link and the second link to pivot with respect to each other as the chain is driven around the bar;
wherein each of the first link and the second link has at least one lateral side with one or more recesses that reduce the contact surface of the lateral side.

24. A device incorporating a cutting chain comprising:
a bar; and
a plurality of links arranged in a chain along a chain path around the bar, wherein a first link comprises a hook that engages a recess of a second link, thereby coupling the first link and the second link and allowing the first link and the second link to pivot with respect to each other as the chain is driven around the bar; and
further comprising at least one spacer link.

25. The device as recited in claim 24, wherein the at least one spacer link has two hooks or two recesses.

26. The device as recited in claim 24, wherein the at least one spacer link does not have any cutting teeth.
